(19) United States
(12) Patent Application Publication
(10) Pub. No.: US 2024/0200575 A1
(43) Pub. Date: Jun. 20, 2024

(54) ROTATING APPARATUS, MOTOR, AND PUMP

(71) Applicant: National University Corporation Saitama University, Saitama (JP)

(72) Inventors: Masaya TAKASAKI, Saitama-shi (JP); Yuki NAKASUJI, Saitama-shi (JP); Hayato SHIBATA, Saitama-shi (JP); Takehiro ISHIDA, Saitama-shi (JP)

(73) Assignee: National University Corporation Saitama University, Saitama (JP)

(21) Appl. No.: 18/590,487

(22) Filed: Feb. 28, 2024

Related U.S. Application Data
(63) Continuation of application No. PCT/JP2022/029181, filed on Jul. 28, 2022.

(30) Foreign Application Priority Data
Aug. 30, 2021 (JP) 2021-140218
Feb. 24, 2022 (JP) 2022-026548

(51) Int. Cl. F04D 29/66; F04D 29/38; H02N 2/10

(52) U.S. Cl. CPC F04D 29/661; F04D 29/384; H02N 2/103

(57) ABSTRACT

Provided is a novel technique that utilizes a vibrator and is applicable to various uses. This rotating apparatus comprises a vibrator having a vibrating surface that is perpendicular to a direction of vibration, and an opposing element that has an opposing surface facing the vibrating surface and rotates about the vibration direction of the vibrator. The vibrating surface and the opposing surface have parallel regions that face each other in parallel, and an impeller region formed in a three-dimensional manner on at least one of the surfaces.

### TECHNICAL FIELD

The present invention is related to a rotating apparatus, motor, and pump.

### BACKGROUND ART

In recent years, vibration waves such as ultrasonic waves have been used in various applications. Patent Document 1 discloses a technique to obtain a pump effect using ultrasonic waves with a simple structure. Non-Patent Document 1 discloses a phenomenon in which when an object is brought close to a vibrator, the object is attracted to the vibrator.

### PRIOR ART LITERATURE

### Patent Document

Patent Document 1: Unexamined Patent Publication No. 2013-068136

### Non-Patent Document

Non-Patent Document 1: T. Hatanaka, Y. Koike, K. Nakamura, S. Ueha, Y. Hashimoto, “Characteristics of Underwater Near-Field Acoustic Radiation Force Acting on a Planar Object”, Japanese Journal of Applied Physics, Vol. 38 (1999), No. 11A, pp. L1284-L1285

### SUMMARY OF THE INVENTION

### Problem to be Solved by the Invention

A novel technique that utilizes a vibrator and its applicability to various uses is expected.

The purpose of the present invention is to provide a novel technique that utilizes a vibrator and can be applied to various uses.

### Means for Solving the Problem

The rotating apparatus, according to an aspect of the present invention, comprises a vibrator having a vibrating surface perpendicular to the vibration direction; and an opposing element that has an opposing surface facing the vibrating surface and rotating with the vibration direction of the vibrator as the axis, wherein the vibrating surface and the opposing surface each have a parallel region that face each other in parallel and an impeller region that is three-dimensionally formed in at least one of the parallel regions.

### Effect of the Invention

The present invention provides a novel technique that utilizes a vibrator and can be applied to various applications.

### BRIEF DESCRIPTION OF THE DRAWINGS

FIG. 1 is a conceptual diagram to illustrate an example of the configuration of a rotating apparatus according to one embodiment.

FIG. 2A is a conceptual diagram to illustrate an example of the configuration of a vibrator according to one embodiment.

FIG. 2B is a conceptual diagram to illustrate an example of the configuration of a vibrator according to one embodiment.

FIG. 3 is a diagram to explain an example of the vibration characteristics of a vibrator according to one embodiment.

FIG. 4A is a schematic diagram to illustrate the shape of a vibrator according to one embodiment.

FIG. 4B is a schematic diagram to illustrate the shape of a vibrator according to one embodiment.

FIG. 4C is a schematic diagram to illustrate the shape of a vibrator according to one embodiment.

FIG. 4D is a schematic diagram to illustrate the shape of a vibrator according to one embodiment.

FIG. 4E is a schematic diagram to illustrate the shape of a vibrator according to one embodiment.

FIG. 5A is a diagram to illustrate the relationship between the vibration amplitude of a vibration device and measurement results of the rotational speed for an opposing element according to one embodiment.

FIG. 5B is a diagram to illustrate the relationship between the vibration amplitude of a vibration device and measurement results of the rotational speed for an opposing element according to one embodiment.

FIG. 5C is a diagram to illustrate the relationship between the vibration amplitude of a vibration device and measurement results of the rotational speed for an opposing element according to one embodiment.

FIG. 5D is a diagram to illustrate the relationship between the vibration amplitude of a vibration device and measurement results of the rotational speed for an opposing element according to one embodiment.

FIG. 5E is a diagram to illustrate the relationship between the vibration amplitude of a vibration device and measurement results of the rotational speed for an opposing element according to one embodiment.

FIG. 6 is a conceptual diagram to explain the rotation direction of an opposing element according to one embodiment.

FIG. 7A is a conceptual diagram to explain a modification example of a rotating apparatus according to one embodiment.

FIG. 7B is a conceptual diagram to explain a modification example of an opposing element according to one embodiment.

FIG. 8A is a conceptual diagram to explain a modification example of a rotating apparatus according to one embodiment.

FIG. 8B is a conceptual diagram to explain a modification example of a rotating apparatus according to one embodiment.

FIG. 9A is a conceptual diagram to explain a modification example of a rotating apparatus according to one embodiment.

FIG. 9B is a conceptual diagram to explain a modification example of an opposing element according to one embodiment.

FIG. 9C is a conceptual diagram to explain a modification example of a rotating apparatus according to one embodiment.

FIG. 9D is a conceptual diagram to explain a modification example of a rotating apparatus according to one embodiment.

FIG. 9E is a conceptual diagram to explain a modification example of a rotating apparatus according to one embodiment.

FIG. 10A is a conceptual diagram to explain a modification example of a vibration device according to one embodiment.

FIG. 10B is a conceptual diagram to explain a modification example of a vibration device according to one embodiment.

FIG. 11 is a conceptual diagram to explain a modification example of an opposing element according to one embodiment.

FIG. 12 is a conceptual diagram to explain a modification example of an opposing element according to one embodiment.

FIG. 13 is a conceptual diagram to explain a modification example of an opposing element according to one embodiment.

FIG. 14 is a conceptual diagram to explain a modification example of an opposing element according to one embodiment.

FIG. 15 is a conceptual diagram to explain a modification example of an opposing element according to one embodiment.

FIG. 16 is a conceptual diagram to explain a modification example of an opposing element according to one embodiment.

FIG. 17 is a conceptual diagram to explain a modification example of an opposing element according to one embodiment.

FIG. 18 is a conceptual diagram to explain a modification example of an opposing element according to one embodiment.

FIG. 19 is a conceptual diagram to explain a modification example of an opposing element according to one embodiment.

FIG. 20 is a conceptual diagram to explain a modification example of an opposing element according to one embodiment.

FIG. 21 is a conceptual diagram to explain a modification example of an opposing element according to one embodiment.

FIG. 22 is a conceptual diagram to explain a modification example of an opposing element according to one embodiment.

FIG. 23 is a conceptual diagram to explain a modification example of an opposing element according to one embodiment.

FIG. 24 is a conceptual diagram to explain a modification example of an opposing element according to one embodiment.

FIG. 25 is a conceptual diagram to explain a modification example of an opposing element according to one embodiment.

FIG. 26 is a conceptual diagram to explain a modification example of an opposing element according to one embodiment.

FIG. 27 is a conceptual diagram to explain a modification example of an opposing element according to one embodiment.

FIG. 28 is a conceptual diagram to explain a modification example of an opposing element according to one embodiment.

FIG. 29 is a conceptual diagram to explain a modification example of an opposing element according to one embodiment.

FIG. 30 is a conceptual diagram to explain a modification example of an opposing element according to one embodiment.

FIG. 31 is a table to explain a modification example of an opposing element according to one embodiment.

FIG. 32 is a table to explain a modification example of an opposing element according to one embodiment.

FIG. 33 is a graph to explain a modification example of an opposing element according to one embodiment.

### DETAILED DESCRIPTION OF THE INVENTION

Referring to the drawings, one embodiment of the present invention will described below. In the description of the drawings, identical or similar parts are labeled with the same or similar reference numerals. The drawings are schematic, and the relationship between the thickness and the planar dimension, the ratio of the thickness of each layer, etc., may differ from the actual parts. Furthermore, some portions with different dimensional relationships and ratios between the drawings may be present.

### <Configuration of Apparatus>

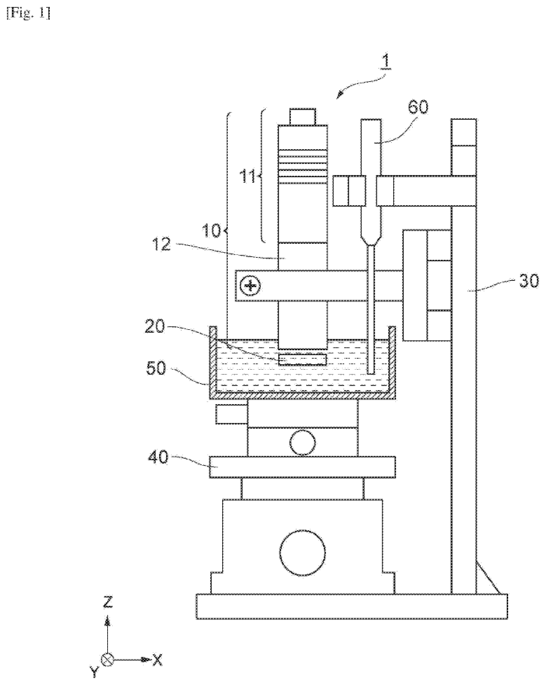

Referring to FIG. 1, an example of a rotating apparatus according to this embodiment will be described. As shown in FIG. 1, rotating apparatus 1 includes vibration device 10 and opposing element 20. Vibration device 10 includes vibrator 11 and horn 12. In this embodiment, vibration device 10 may also be called a vibrator.

Vibration device 10 is fixed by fixture 30 so that the longitudinal direction of the vibration device 10, which is the vibration direction of vibration device 10, is the direction of gravity. Vibration device 10 has a planar and circular vibration surface perpendicular to the vibration direction at one end (lower end of the example shown in FIG. 1) along the longitudinal direction of vibration device 10. Vibration device 10 is connected to a power source (not shown) to obtain driving power. Vibration device 10 has a circuit as a control unit (not shown) for generating and controlling vibrations.

The lower end of vibration device 10 and opposing element 20 are submerged in the water filled in water tank 50. The position of water tank 50 in the Z-axis direction is adjusted by Z-axis stage 40. Temperature probe 60 is fixed by fixture 30 in water tank 50 to measure the water temperature.

Opposing element 20 is, for example, a plate shape, such as a disk. Opposing element 20 has two circular surface portions. At least one of the two circular surface portions of opposing element 20 has a planar region and an impeller region.

When the surface portion of opposing element 20 and the vibrating surface of vibration device 10 are in parallel opposing positions, the planar region of the surface portion (opposing surface) of opposing element 20 is also referred to as the parallel region in the following description, as it is parallel to the vibrating surface of vibration device 10. The impeller region refers to the area where a three-dimensional impeller shape is formed. In the impeller region, a point-symmetric three-dimensional pattern that is not an impeller shape may be formed.

The diameter of the surface portion of opposing element 20 and the diameter of the vibrating surface of vibration device 10 are equal. Here, the same diameter does not necessarily mean exactly the same diameter. For example, there may be a 1 to 5% difference between the diameter of the surface portion of opposing element 20 and the diameter of the vibrating surface of vibration device 10.

When vibration device 10 is vibrated with the lower end of the vibration device 10 submerged in the water in water tank 50, and the surface portion (opposing surface) of opposing element 20 with the parallel region and impeller region is brought close to the vibrating surface of the vibrating device 10, the opposing surface of opposing element 20 is kept attracted to the vibrating surface of vibration device 10. Rotating apparatus 1 does not have a member to support opposing element 20. The vibration by vibration device 10 is not limited; for example, it is ultrasonic wave vibration with a frequency of 20 kHz or more. The vibration by vibration device 10 is not limited; for example, it is a single vibration. The detailed principle of the phenomenon in which an object is attracted to the vibrating surface of the vibrator has not been elucidated; however, the phenomenon is reported in non-patent document 1.

When vibration device 10 vibrates, and opposing element 20 is attracted, a self-centering effect occurs between the vibrating surface of vibration device 10 and the surface portion of opposing element 20, and the position of the center portion of the vibration surface of vibration device 10 and the position of the center portion of the surface portion of opposing element 20 come close to each other. Further, as described above, the diameter of the surface portion of opposing element 20 and the diameter of the vibrating surface of vibration device 10 are the same. As a result, when vibration device 10 vibrates and the vibrating surface of vibration device 10 and the surface portion of opposing element 20 face each other, the end portion of the vibrating surface of vibration device 10 vibrating surface faces the end portion of the surface portion of opposing element 20 surface portion.

At this time, opposing element 20 rotates about the vibration direction of vibration device 10.

Although the principle of the rotation is not clear, the pressure generated by the vibration of the vibrating surface of the vibration device 10 may cause the water flowing through the gap between vibration device 10 and opposing element 20 and the acoustic flow generated by the vibration of the vibrating surface to strike the surface portion of opposing element 20, which may cause rotation of opposing element 20. The details of the rotation of the opposing element 20 will be described later.

In this embodiment, the surface portion of opposing element 20 has a parallel region and an impeller region but is not limited thereto. Alternatively, the vibrating surface of vibration device 10 may have a parallel region and an impeller region instead of the surface portion of opposing element 20. The same applies to the embodiments described hereinafter.

As described above, according to this embodiment, rotating apparatus 1 includes vibration device 10 (vibrator) and an opposing element 20. Vibration device 10 has a vibrating surface perpendicular to the vibration direction. Opposing element 20 has an opposing surface that faces the vibrating surface of vibration device 10 and rotates about the vibration direction of vibration device 10. The vibrating surface of vibration device 10 and the opposing surface of opposing element 20 each have a parallel region that face each other in parallel and an impeller region three-dimensionally formed in at least one of the parallel regions.

Rotating apparatus 1, with its above-described configuration, enables the realization of a novel rotation device that utilizes vibration device 10. In particular, since opposing element 20 rotates without contacting vibration device 10, wear and damage due to contact with vibration device 10 are less likely to occur. As a result, rotating apparatus 1 having high durability can be realized.

Examples of vibration device 10 and opposing element 20 in this embodiment are described in detail below.

### <Vibration Device>

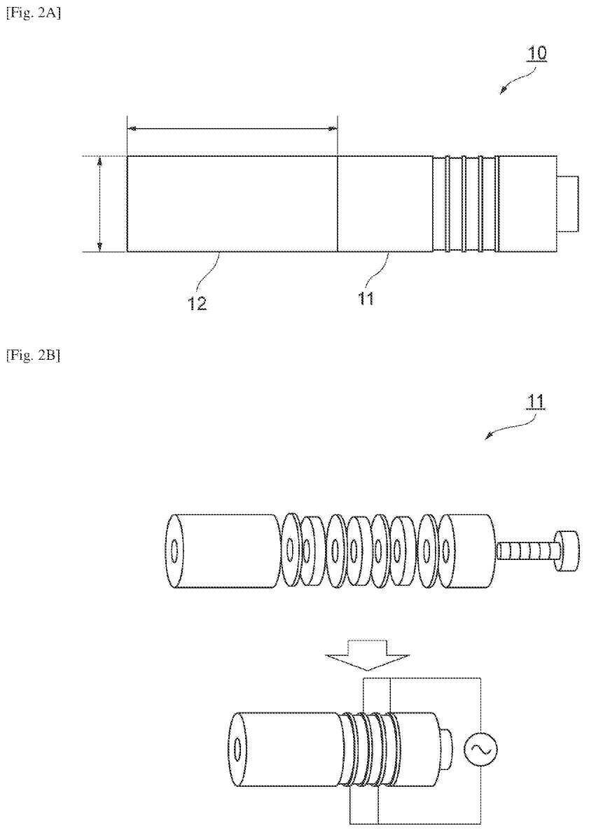

Referring to FIG. 2A and FIG. 2B, an exemplary configuration of vibration device 10 in this embodiment will be described. Vibration device 10 may be configured to generate vibrations, and the specific configuration thereof is not limited to the configurations described below. Vibrator 11 of vibration device 10 is configured by alternately sandwiching a doughnut-shaped piezoelectric ceramic and an electrode plate, further sandwiching both ends thereof by a metal block, and fastening them with a through bolt. Voltage is applied to the electrode plate so that vibrator 11 is polarized in its axial direction.

Applying an AC voltage from the circuit to the electrode plate causes expansion and contraction due to the reverse piezoelectric effect, and vibrator 11 vibrates in a unidirectional vibration mode. Vibrator 11 is configured by tightening with a through bolt so that even a piezoelectric ceramic, weak against tensile force, can withstand the vibration amplitude and operate as a high-output vibrator.

Horn 12 is connected to one axial end of vibrator 11. Horn 12 is a member connected to vibrator 11 so that the vibrating surface of vibration device 10 satisfies the required conditions, such as the shape, pattern, presence of a hole, and material. In the example shown in FIG. 2, horn 12 is configured in a cylindrical shape. The bottom surface of horn 12, which serves as the vibrating surface of vibration device 10, is formed in a circular shape. Horn 12 is connected to vibrator 11 such that its axis is coaxial with the axis of vibrator 11. Horn 12 can be composed of any material; for example, it can be made of metal components such as stainless steel.

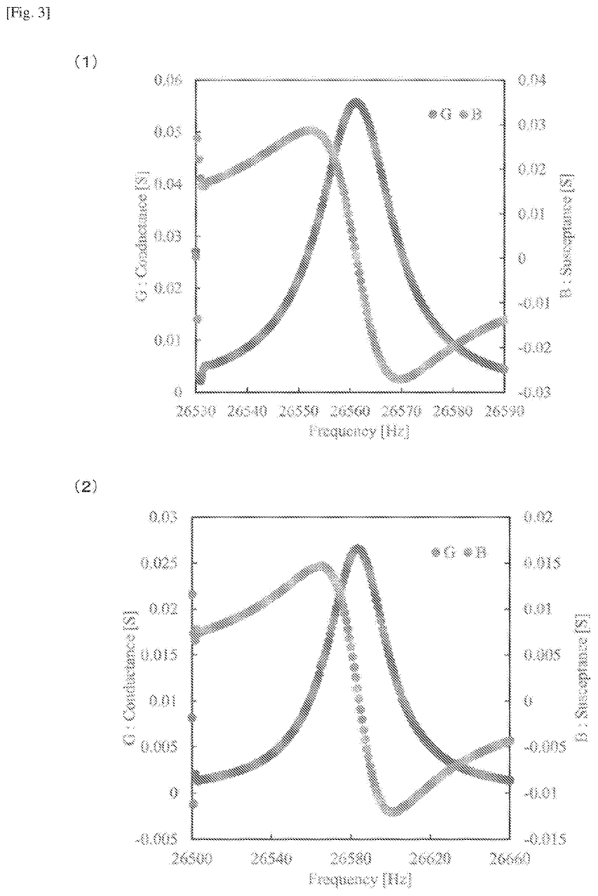

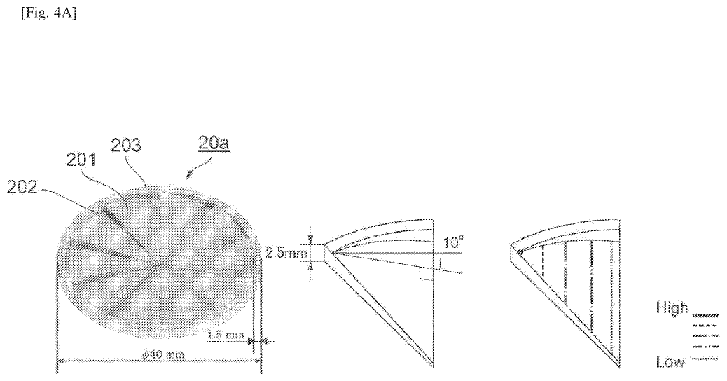

Referring to FIG. 3, an example of vibration characteristics of exemplary vibrator 11 used in vibration device 10 in this embodiment is described; however, the vibration characteristic is not limited thereto. The measurement results of the vibration characteristics of vibration device 10 in a state secured by fixture 30 using an impedance analyzer are shown in FIG. 3. FIG. 3 shows the relationship between the frequency of the AC voltage in the circuit of vibration device 10 and the conductance (real part G) and susceptance (imaginary part B) of admittance. FIG. 3(1) shows the results of measuring the vibration characteristics of vibration device 10 in air. FIG. 3(2) shows the results of measuring the vibration characteristics of vibration device 10 in water. The frequency at which the real part G takes the maximum value (unit [S]) is the resonance frequency of vibration device 10. According to FIG. 3, vibration device 10 resonates at a frequency of 26.5 to 26.6 kHz in air and water. The phase measurement of admittance is used to follow the resonance frequency of vibration device 10. According to FIG. 3, the maximum value of real part G in the water is about half the maximum value of real part G in the air. Thus, to obtain the same vibration amplitude in water and air, FIG. 3 shows that it is necessary to apply approximately twice the voltage applied in the air to obtain the same amplitude in water.

### <Opposing Element>

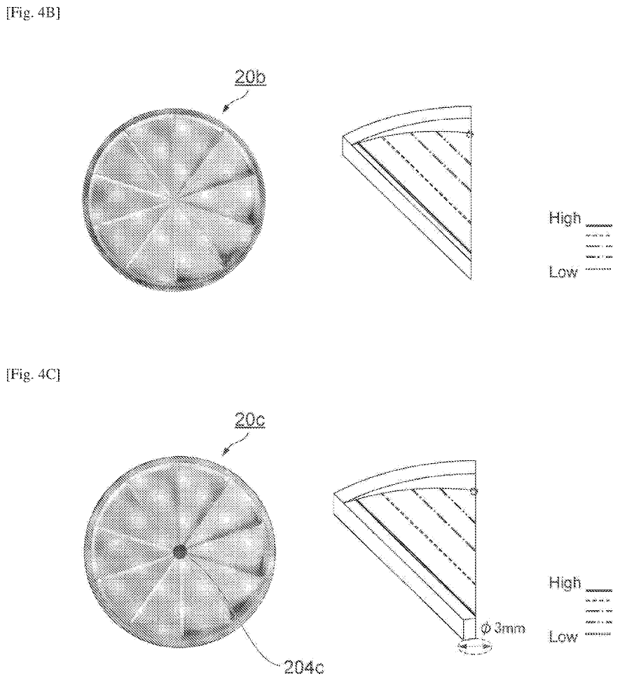

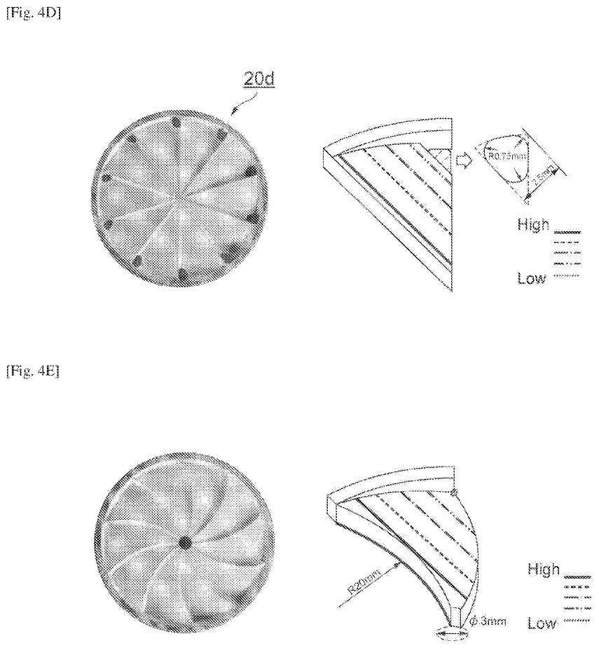

Referring to FIGS. 4A through 4E, a plurality of examples for the shape of the opposing element 20 in this embodiment will be described. In the example shown in FIG. 4A, opposing element 20a has a disk shape. At least one of the two circular surface portions of opposing element 20a has an impeller region and planar region 203 surrounding the impeller region. The impeller region has a plurality of inclined surfaces 201 and a plurality of vertical surfaces 202. Inclined surface 201 is a fan-shaped surface inclined with respect to planar region 203. Inclined surface 201 is inclined toward the other radial line of inclined surface 201 with the contact point of planar region 203 and the radial line as the apex. The inclination angle is not limited; for example, it is 10° with respect to planar region 203. Vertical surface 202 is a plane perpendicular to planar region 203 and extends between the end portions of two inclined surfaces 201. In the impeller region, a plurality of tangents (hereinafter referred to as “radial lines”) where inclined surface 201 and vertical surface 202 meet extend radially from the center portion of the impeller region to planar region 203.

In the example shown in FIG. 4A, opposing element 20a has a convex portion formed on the surface portion along the end portion of the surface portion and has planar region 203 as its top surface. Since the convex portion is higher than the impeller region, in this embodiment, the convex portion of opposing element 20a is also referred to as an edge, and the portion recessed from planar region 203 in the impeller region is also referred to as the concave portion.

Since the vibrating surface of vibration device 10 and the surface portion (opposing surface) having a convex portion and concave portion of opposing element 20a face each other, a space is formed between the vibrating surface of vibration device 10 and the opposing surface of opposing element 20a. In this case, the vibrating surface of vibration device 10 is not in contact with the convex portion of opposing element 20a, and a predetermined distance exists between the vibrating surface of vibration device 10 and the convex portion of opposing element 20a.

Furthermore, in the example shown in FIG. 4A, although not limited, the diameter of the circular surface portion of opposing element 20a is 40 mm, and the width in the lateral direction of the top surface of planar region 203 is 1.5 mm. The thickness of opposing element 20a is 2.5 mm.

As described above, the surface portion of opposing element 20a and the vibrating surface of vibration device 10 is circular, and the diameter of the surface portion of opposing element 20a and the diameter of the vibrating surface of vibration device 10 are equal.

As a result, when vibration device 10 vibrates and the vibrating surface of the vibration device 10 and the surface portion of opposing element 20a face each other, the end portion of the vibrating surface of vibration device 10 faces the end portion of the surface portion of opposing element 20a.

An example of opposing element 20 shown in FIGS. 4B through 4E are described, focusing on the difference with the opposing element 20a shown in FIG. 4A or other examples of opposing element 20.

The inclination method of inclined surface 201 of opposing element 20b, shown in FIG. 4B, differs from opposing element 20a. Inclined surface 201 of opposing element 20b has the highest position at one radial line of inclined surface 201 and is inclined toward the contact point between the other radial line and planar region 203.

Opposing element 20c, shown in FIG. 4C, differs from opposing element 20b in that it has through-hole 204c at the center of the surface portion. Specifically, opposing element 20c has a through-hole 204c formed from the center of one of the two parallel and opposing surface portions of opposing element 20c toward the other surface portion (back surface of opposing element 20c). Although the diameter of through-hole 204c is not limited, it is 3 mm. As described later, having through-hole 204c at the center of the impeller region makes the rotation of opposing element 20c more stable.

Opposing element 20d, shown in FIG. 4D, differs from opposing element 20c in that it has through-hole 204c at the contact point between the radial line and planar region 203 rather than the center of the surface portion.

Vertical surface 202e of opposing element 20e shown in FIG. 4E differs from the planar vertical surface 202 of opposing element 20a and is curved. In the example shown in FIG. 4E, vertical surface 202e is curved to form a recess in the top view. Opposing element 20e is different from opposing element 20a in that it has a through-hole 204e at the center of the surface portion.

### <Measurement Results>

The following is a description of measurement results of the rotational characteristics of opposing element 20 when rotating apparatus 1, shown in FIG. 1, is configured and opposing element 20a to opposing element 20e shown in FIG. 4A through 4E are employed as opposing element 20 of rotating apparatus 1.

For measuring the rotational characteristics of opposing element 20, an AC voltage is generated by a function generator, amplified by a high-speed amplifier and applied to vibrator 11 of vibration device 10, and vibrator 11 is excited. The frequency of the applied AC voltage is 26.5 kHz, which is the resonance frequency of vibrator 11. The temperature of the water in water tank 50, in which the lower end of vibration device 10 and opposing element 20 are immersed, is kept in the range of 20° C. to 30° C. The rotational speed of opposing element 20 was measured by a stopwatch with the naked eye during low-speed rotation and measured from the video captured during high-speed rotation.

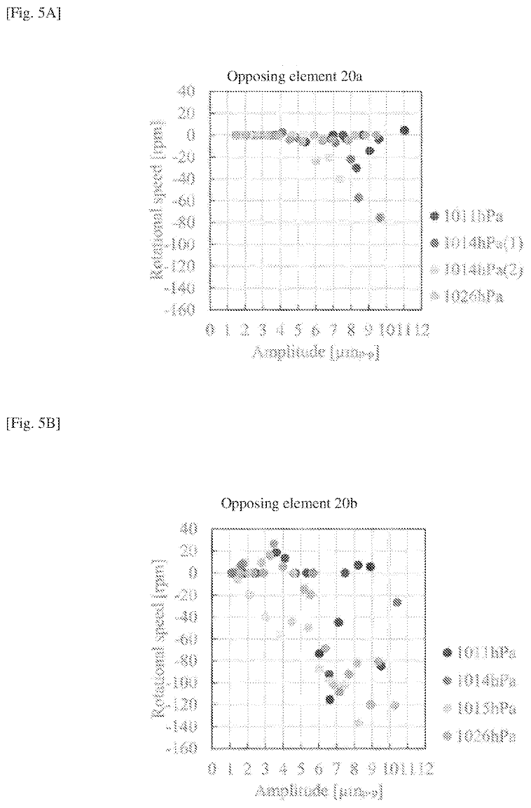

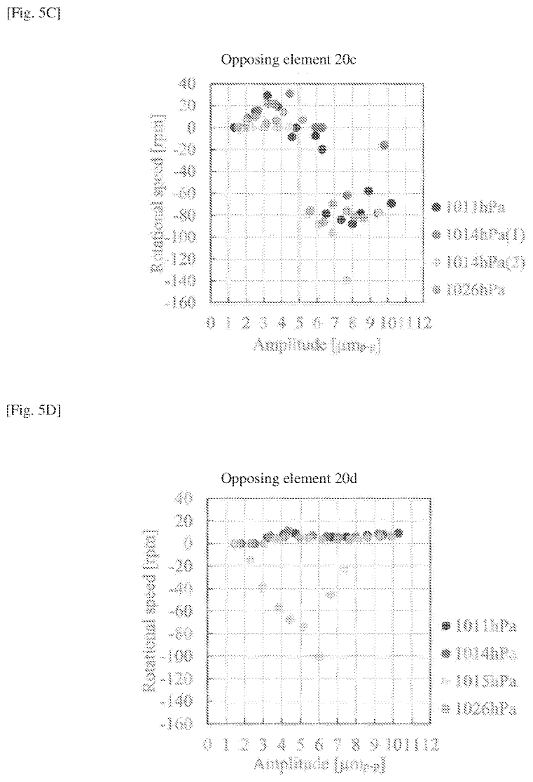

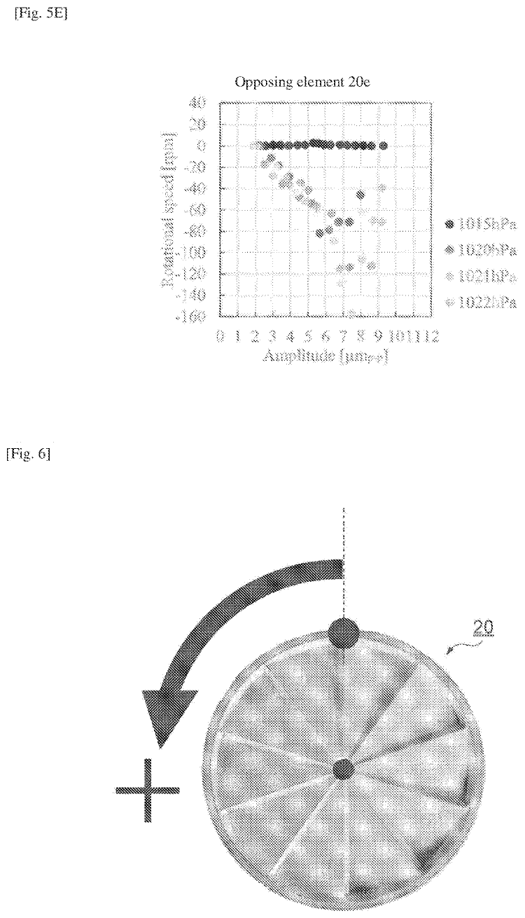

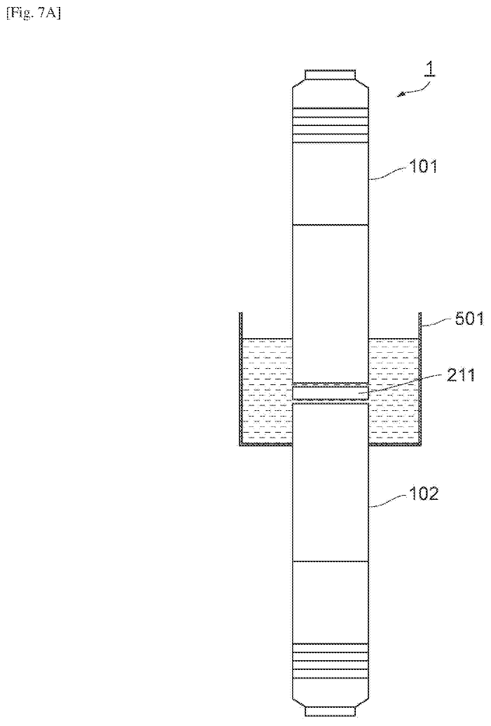

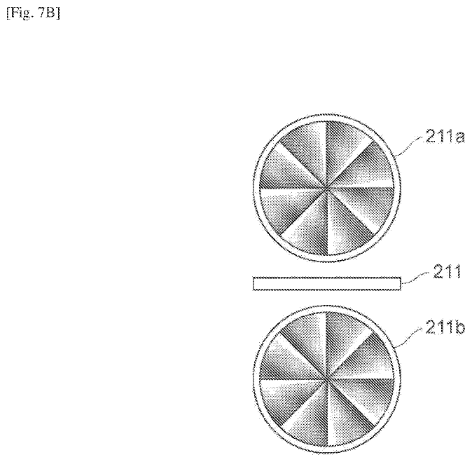

FIGS. 5A through 5E show the measurement results of the rotational speed of the opposing element with respect to the vibration amplitude of vibration device 10 for each of the opposing elements 20a to 20e. The measurement results are shown for each condition of atmospheric pressure.

As shown in FIG. 6, the counterclockwise rotation in the top view of the impeller region of opposing element 20 is defined as the forward rotation of opposing element 20, and the rotational speed is shown as a positive value in FIGS. 5A through 5 E. On the other hand, the clockwise rotation is defined as the reverse direction of opposing element 20, and the rotational speed is shown as a negative value in FIGS. 5A through 5E.

It can be seen from FIGS. 5a through 5e that different shapes of the opposing element 20 exhibit different rotational characteristics. For example, opposing elements 20b, 20c, and 20e tend to have a higher rotational speed as the vibration amplitude of vibration device 10 increases. Also, opposing elements 20c and 20e, each having a through-hole at the center of the surface portion (impeller region), have less variation in measurement results than other opposing elements 20. Therefore, having a through-hole at the center of the surface portion makes it possible to understand that the rotation of opposing element 20c is more stable.

A modification example of this embodiment will be described. The contents of each of the plurality of modification examples described below are applicable, as appropriate, to the above embodiment and other modification examples. In the description of the following modification examples, the same reference numerals are appropriately assigned to the same configuration as the above embodiment, and the description thereof is omitted or simplified.

### Modification Example 1

In the above embodiment, rotating apparatus 1 has one vibration device, but in modification example 1, rotating apparatus 1 has two vibration devices.

Referring to FIGS. 7A and 7B, a schematic configuration of rotating apparatus 1 in modification example 1 will be described. Rotating apparatus 1 is provided with vibration device 101, vibration device 102, and opposing element 211. Vibration device 101 and vibration device 102 are configured similarly to vibration device 10.

Vibration device 101 has vibration surface No. 1 perpendicular to the vibration direction. Vibration device 102 has vibration surface No. 2 perpendicular to the vibration direction. In rotating apparatus 1 of modification example 1, vibration device 101 and vibration device 102 are installed such that vibration surface No. 1 and vibration surface No. 2 face each other. An opposing element 211 is interposed between vibration surface No. 1 and vibration surface No. 2. Opposing element 211 is, for example, a plate shape, such as a disk. Opposing element 211 has two circular surface portions.

As shown in FIG. 7A, vibration surface No. 1, vibration surface No. 2 and opposing element 211 are immersed in the water filled in water tank 501.

As shown in FIG. 7B, No. 1 surface portion 211a and No. 2 surface portion 211b of opposing element 211 have a planar region and an impeller region similar to those described above. When opposing element 211 is placed between the vibration surface No. 1 and vibration surface No. 2, No. 1 surface portion 211a becomes an opposing surface of vibration surface No. 1, and No. 2 surface portion 211b becomes an opposing surface of vibration surface No. 2. The diameters of No. 1 surface portion 211a and No. 2 surface portion 211b and the diameters of vibration surface No. 1 and vibration surface No. 2 are equal. The impeller region may be formed on vibration surface No. 1 and vibration surface No. 2 instead of No. 1 surface portion 211a and No. 2 surface portion 211b.

When vibration device 101 and vibration device 102 vibrate, a self-centering effect occurs between vibration surface No. 1 and vibration surface No. 2 and No. 1 surface portion 211a and No. 2 surface portion 211b, causing the positions of the center portions of vibration surface No. 1 and vibration surface No. 2 and the positions of No. 1 surface portion 211a and No. 2 surface portion 211b to come close to each other. At this time, opposing element 211 rotates about the vibration direction of vibration device 101 and vibration device 102.

The impeller regions of No. 1 surface portion 211a and No. 2 surface portion 211b are formed in such a shape that the rotational force generated by the water flow and acoustic flow striking No. 1 surface portion 211a and the rotational force generated by the water flow and the acoustic flow striking No. 2 surface portion 211b do not repel each other.

According to rotating apparatus 1 of modification example 1, vibration device 101 has vibration surface No. 1 perpendicular to the vibration direction. Vibration device 102 has vibration surface No. 2 perpendicular to the vibration direction. Opposing element 211 has No. 1 surface portion 211a facing vibration surface No. 1 and No. 2 surface portion 211b facing vibration surface No. 2. Vibration surface No. 1 and No. 1 surface portion 211a (opposing surface No. 1) each have a parallel region No. 1 that face each other in parallel and impeller region No. 1 that is three-dimensionally formed in at least one of the parallel regions No. 1. Vibration surface No. 2 and No. 2 surface portion 211b (opposing surface No. 2) each have a parallel region No. 2 that face each other in parallel and impeller region No. 2 that is three-dimensionally formed in at least one of the parallel regions No. 2. Opposing element 211 rotates about the vibration direction of vibration device 101 and vibration device 102.

In modification example 1, since the vibration of two vibration devices generates the rotation force of opposing element 211, the rotational torque of opposing element 211 can be increased.

### Modification Example 2

In modification example 2, a through-hole formed toward the outside through the inside of the vibration device is provided on the vibrating surface of the vibration device of rotating apparatus 1, and the fluid is sucked up from the through-hole.

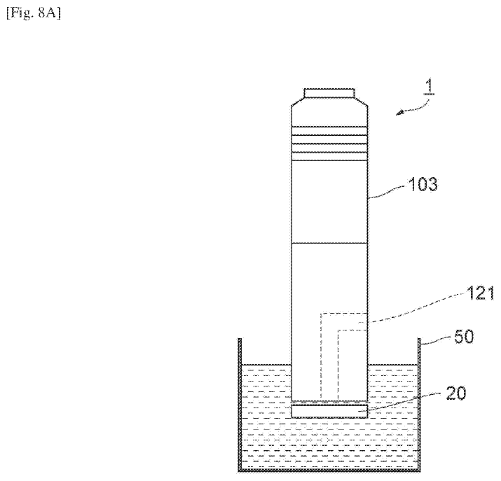

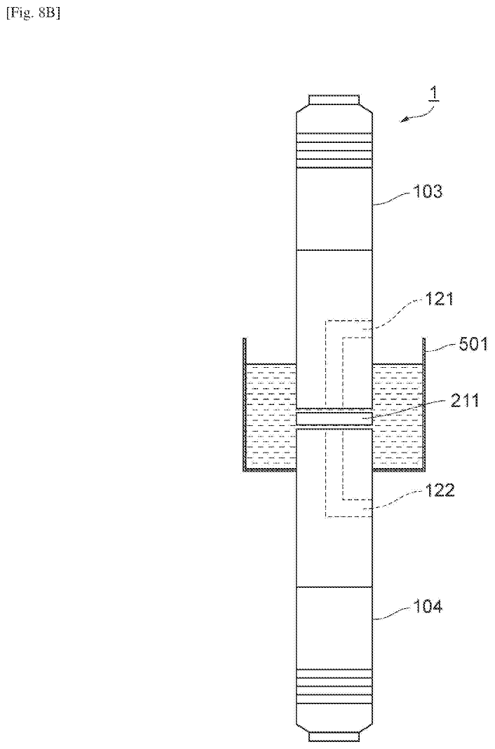

As shown in FIG. 8A, in modification example 2, rotating apparatus 1 is provided with vibration device 103. In vibration device 103, a through-hole 121 formed toward the outside of vibration device 103 through the inside of vibration device 103 is provided on a vibrating surface perpendicular to the vibration direction. Rotating apparatus 1 is configured similarly to rotating apparatus 1 of the above embodiment, except that through-hole 121 is provided in vibration device 103.

When vibration device 103 is vibrated with the lower end of vibration device 103, including the vibrating surface submerged in the water of water tank 50, the parallel region of opposing element 20 and the surface portions (opposing surfaces) having the impeller region are brought closer to the vibrating surface of vibration device 103, the opposing surface of opposing element 20 is kept attracted to the vibrating surface of vibration device 103. At this time, the pressure generated by the vibration of the vibrating surface of vibration device 103 generates a water flow that flows through the gap between vibration device 103 and opposing element 20. Also, the vibration of the vibrating surface generates an acoustic flow. The water flow and the acoustic flow strike the surface portion of opposing element 20, thereby generating rotation of opposing element 20. Also, due to the water flow, the acoustic flow, and the rotation of opposing element 20, a negative pressure is generated in the space formed between the vibrating surface of vibration device 103 and the surface portion of opposing element 20, and the fluid (water) is sucked into the space. As a result, a pump effect is generated, and the fluid flowing into the space is sucked into through-hole 121 of the vibrating surface and discharged to the outside through the inside of vibration device 103.

In modification example 2, rotating apparatus 1 has two vibration devices similar to modification example 1, and a through-hole may be provided in each of the two vibration devices.

Referring to FIG. 8B, in modification example 2, a schematic configuration is described where rotating apparatus 1 has two vibration devices. Rotating apparatus 1 includes vibration device 103 and vibration device 104. Vibration device 104 is configured similarly to vibration device 103, and through-hole 122 formed toward the outside of vibration device 104 through the inside of vibration device 104 is provided on the vibrating surface perpendicular to the vibration direction.

Rotating apparatus 1, shown in FIG. 8B, is configured similarly to rotating apparatus 1 of modification example 1, except that through-hole 121 and through-hole 122 are provided.

For rotating apparatus 1, shown in FIG. 8B, a pump effect is generated in respective spaces formed by the vibrating surfaces of vibration device 103 and vibration device 104 and the two surface portions of opposing elements 211, and the fluid flowing through the space is drawn into each of through-hole 121 and through-hole 122 on the vibrating surface, and discharged to the outside through the inside of vibration device 103 and vibration device 104.

### Modification Example 3

In the above-described embodiment and modification examples, the vibrating surface of the vibration device and the opposing element are operated in water; however, in modification example 3, these are operated in the air.

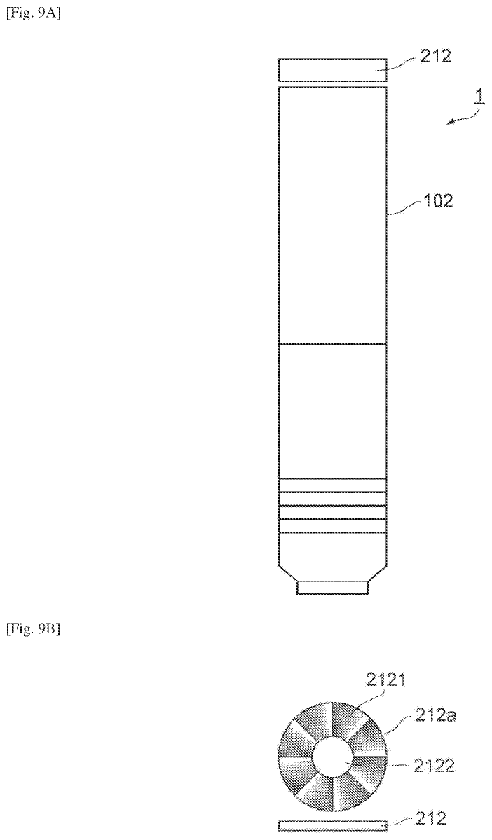

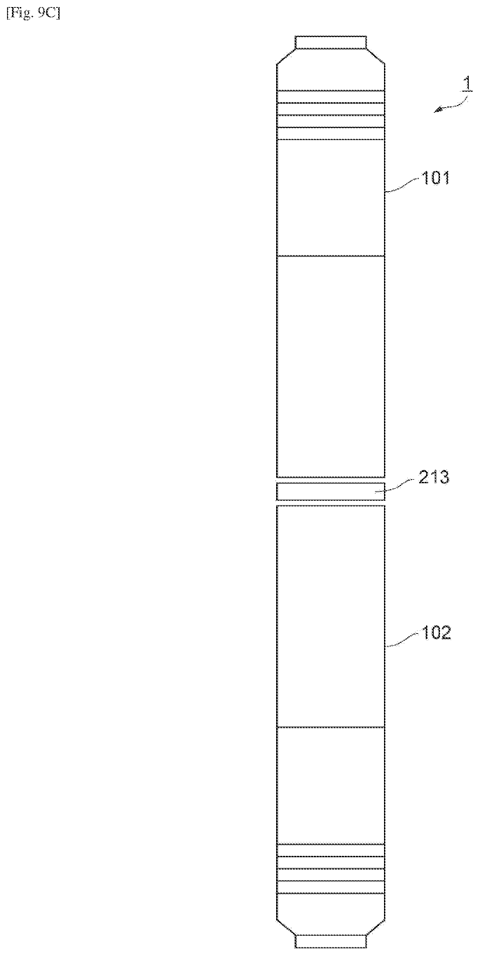

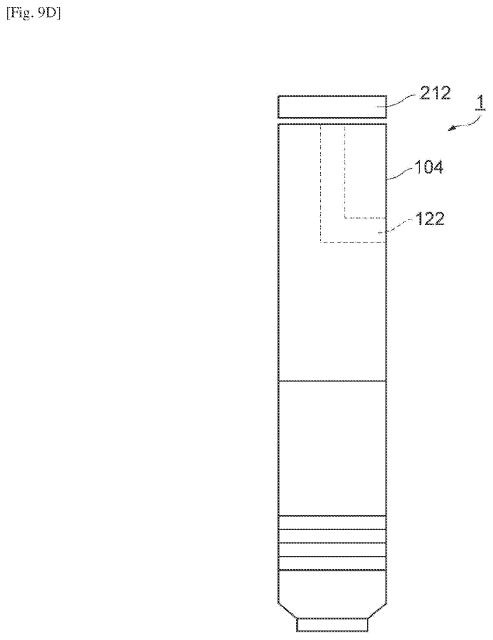

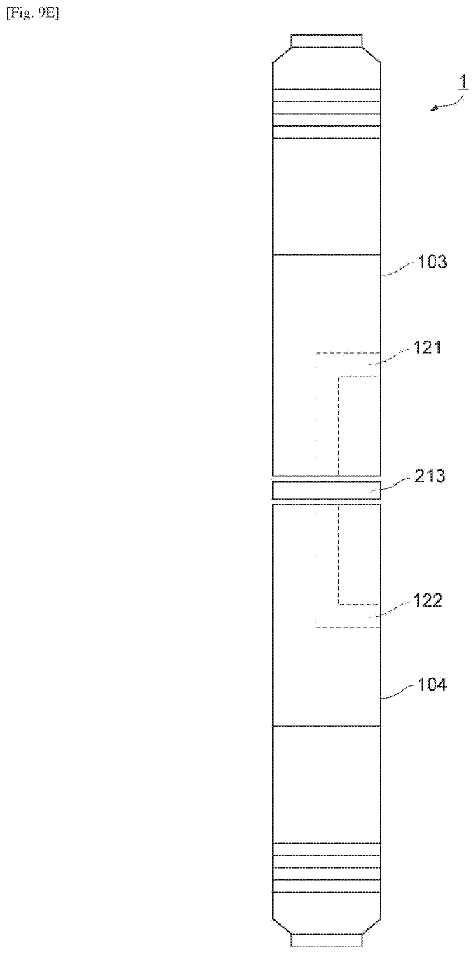

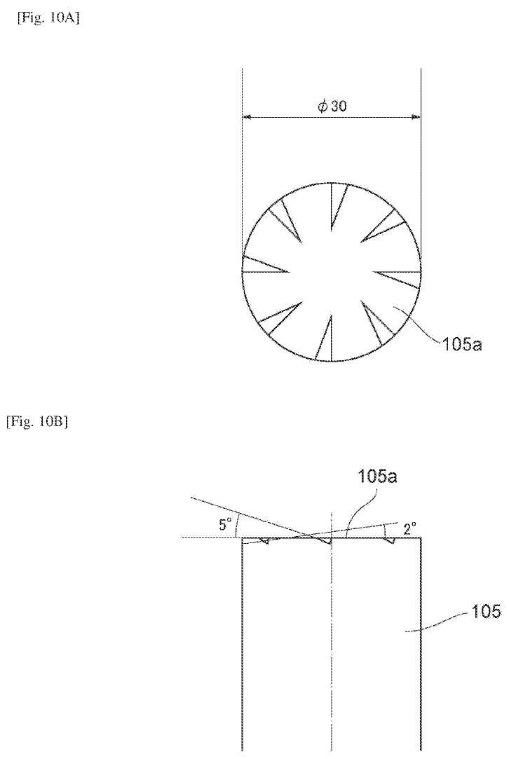

As shown in FIG. 9A, rotating apparatus 1 includes a vibration device 102 and an opposing element 212. Vibration device 102 has a vibrating surface perpendicular to the vibration direction, and vibration device 102 is installed so that the vibration surface faces vertically upward.

As shown in FIG. 9B, surface portion 212a of opposing element 212 facing the vibrating surface of vibration device 102 has planar region 2122, a plane parallel to the vibrating surface of vibration device 102, and an impeller region 2121 in which a three-dimensional impeller shape surrounding planar region 2122 is formed. As in the above embodiment, when the opposing element is rotated in water, for example, like planar region 203, the planar region is preferably an edge (provided on the outer periphery of the surface portion). On the other hand, when rotating in the air, as shown in FIG. 9B, planar region 2122 may be provided at the center of surface portion 212a of opposing element 212 or may be provided on the outer periphery of surface portion 212a as an edge on surface portion 212a of opposing element 212.

Opposing element 212 is placed on the vibrating surface of vibration device 102, and vibration device 102 is made to vibrate with high-frequency vibration such as ultrasonic wave vibration, whereby a squeeze film effect is generated on the vibrating surface of vibration device 102, causing opposing element 212 to float. When a positive pressure generated by the squeeze film effect is applied to impeller region 2121, a rotational force is generated, and opposing element 212 rotates around the vibration direction of vibration device 102. At this time, a self-centering effect is generated between the vibrating surface of vibration device 102 and surface portion 212a of opposing element 212, whereby the position of the center portion of the vibrating surface of vibration device 102 and the position of the center portion of surface portion 212a of opposing element 20 come close to each other.

As shown in FIG. 9C, rotating apparatus 1 in modification example 3 may have two vibration devices as in modification example 1. The example of rotating apparatus 1 shown in FIG. 9C includes vibration device 101, vibration device 102, and opposing element 213. Vibration device 101 has vibration surface No. 1 perpendicular to the vibration direction. Vibration device 102 has vibration surface No. 2 that is perpendicular to the vibration direction. Vibration device 101 and vibration device 102 are installed such that vibration surface No. 1 and vibration surface No. 2 face each other.

Opposing element 213 is positioned between vibration surface No. 1 and vibration surface No. 2. Opposing element 213 is, for example, a plate shape, such as a disk. Opposing element 213 has two circular surface portions. The two surface portions are formed with the same shape as surface portion 212a, shown in FIG. 9B.

The impeller regions of the respective surface portions of opposing element 213 are formed in such a shape that the rotational force generated by the pressure applied to each of the two surface portions of opposing element 213 does not repel each other.

In modification example 3, the rotational force of opposing element 213 is generated by the vibration of the two vibration devices, which increases the rotational torque of opposing element 213.

Further, as shown in FIG. 9D and FIG. 9E, of modification example 3, like modification example 2, a through-hole formed toward the outside through the inside of the vibration device may be provided on the vibrating surface of the vibration device of the rotating apparatus, and the fluid may be drawn from the through-hole.

FIG. 9D and FIG. 9E show through-hole 121 provided in vibration device 103 and through-hole 122 provided in vibration device 104. Positive pressure is generated by the squeeze film effect created between the vibrating surfaces of vibration device 103 and vibration device 104 and opposing element 212 or opposing element 213 and by the rotation of opposing element 212 or opposing element 213. As a result, a pump effect is generated, and the fluid (air) flowing into the vicinity of opposing element 212 or opposing element 213 is drawn into through-hole 121 or through-hole 122 of the vibrating surface and discharged to the outside through the inside of vibration device 103 and vibration device 104.

### Modification Example 4

In modification example 4, an impeller region, a region in which a three-dimensional impeller shape is formed, is provided on the vibrating surface of the vibration device. The impeller region of the vibrating surface may be provided in place of the impeller region on the surface portion of the opposing element described in the above embodiment and modification examples, or it may be provided together with the impeller region on the surface portion of the opposing element.

Referring to FIG. 10A and FIG. 10B, an impeller region provided on the vibrating surface of a vibration device is described. FIG. 10A is a front view of vibrating surface 105a of vibration device 105.

FIG. 10B is a side view of vibration device 105. Vibration surface 105a of vibration device 105 is circular and is formed to have the same diameter as the opposing element, for example, 30 mm. By forming a plurality of notches from the circumference of vibrating surface 105a on vibration device 105 in the center direction, a three-dimensional impeller shape is formed on vibrating surface 105a. The base of the notch is inclined with respect to the plane direction of vibrating surface 105a, and the angle of the inclination is, for example, 2°. Vibrating surface 105a is formed with a concave portion having an apex at the center of vibrating surface 105a, and the inclination of the side surface of the cone is, for example, 5° with respect to the plane direction of vibrating surface 105a.

By bringing the opposing element closer to vibrating surface 105a and vibrating vibration device 105, the opposing element rotates in the same manner as in the above embodiment and modification examples.

### Modification Example 5

In the above-described embodiment and modification examples, the surface portion of the opposing element has an impeller shape formed as a three-dimensional shape. Although the shape of the impeller is generally an impeller shape that rotates the rotor under fluid pressure, verification by the applicant has revealed that the three-dimensional shape functions as a rotor even when a three-dimensional shape other than a generally widely recognized shape is provided on the opposing element. Modification example 5 is an example wherein a three-dimensional shape not generally recognized as an impeller shape is formed on the surface portion of the opposing element. In modification example 5, the configurations described in the above embodiment and modification examples may be applied to the configuration, excluding the opposing element.

In modification example 5, for example, the opposing element has an opposing surface that faces the vibrating surface of the vibrator, and the opposing surface has a parallel region that is parallel to the vibrating surface of the vibrator and a plurality of three-dimensional shapes formed to extend towards the end portion of the opposing surface. That is, the vibrating surface and the opposing surface may each have parallel regions that face each other in parallel. The parallel regions may also be planar. The starting point for the formation of the three-dimensional shape extending towards the end portion of the opposing surface may be inside the opposing surface, in particular, at the center portion of the opposing surface.

That is, the three-dimensional shape may be formed on the inner side of the opposing surface or from the center portion of the inner side of the opposing surface toward the end portion of the opposing surface. Also, the three-dimensional shape may be formed with the same width. The parallel region refers to the area where an adsorption force is generated between the vibrating surface of the vibrator when in water, and a lifting force (namely, the repulsive force between the opposing surface and the vibrating surface) of the opposing element is generated due to the squeeze film effect described above, when in air. The three-dimensional shape is an area considered to generate a rotational force of the opposing element under the action of the fluid.

For example, the three-dimensional shape formed to extend toward the end portion of the opposing surface is formed with one or a plurality of grooves or holes. The groove may be referred to as a concave portion. The hole may also be referred to as a through-hole. The three-dimensional shape formed on the opposing surface may be formed with a convex portion.

Although the number of three-dimensional shapes formed on the opposing surface is not limited, it is preferably 4 or more from the perspective of the rotational speed of the opposing element. Furthermore, although the number of three-dimensional shapes formed on the opposing surface is not limited, it is preferably 4 or more and 10 or less from the perspective of the rotational speed of the opposing element.

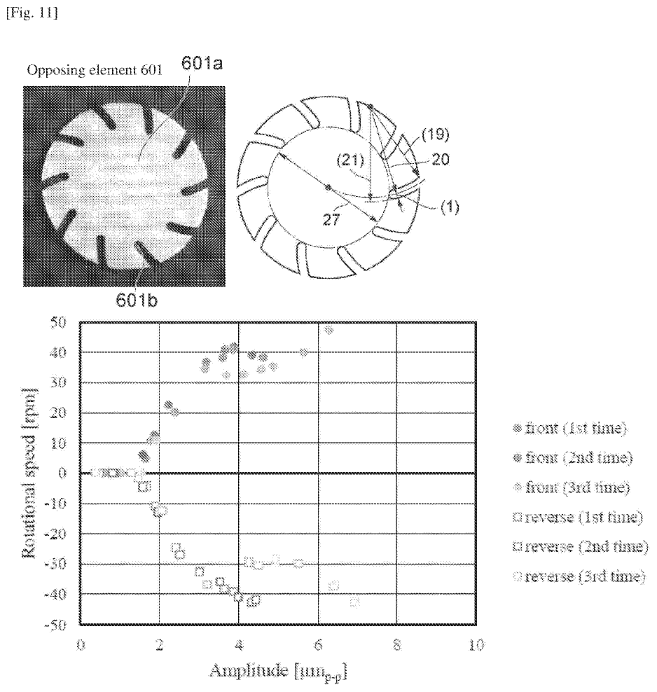

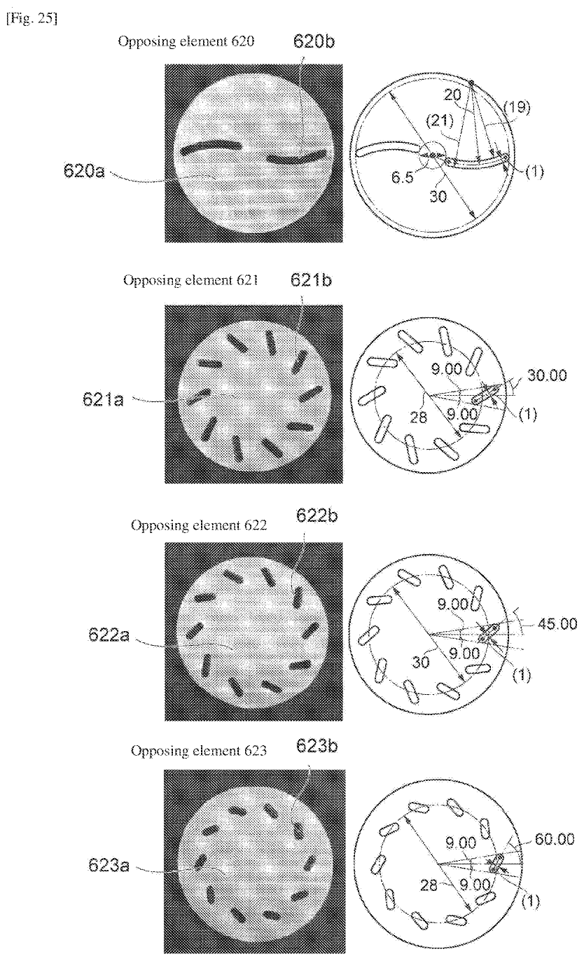

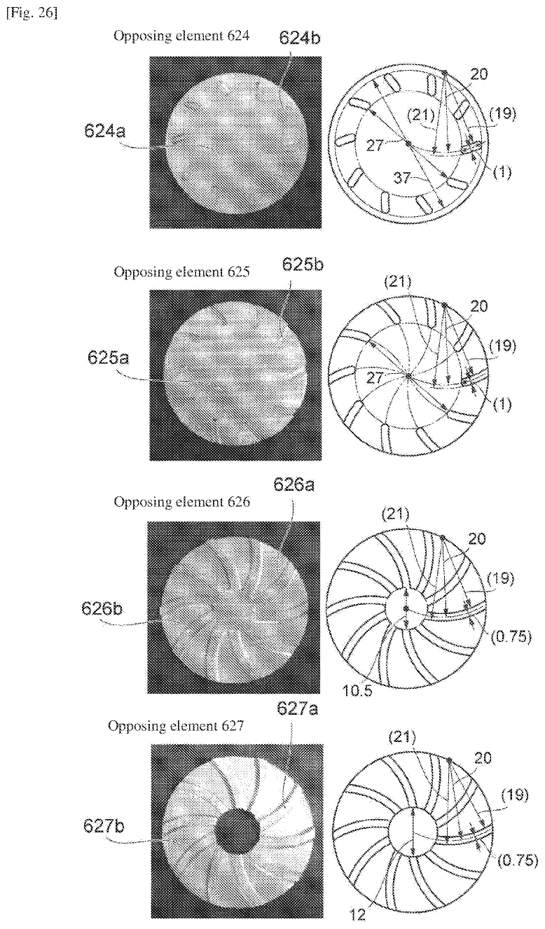

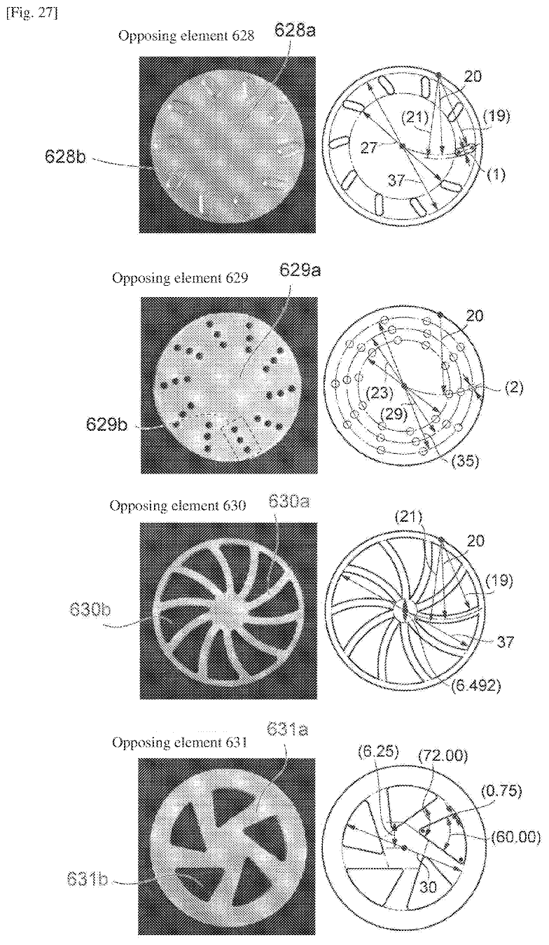

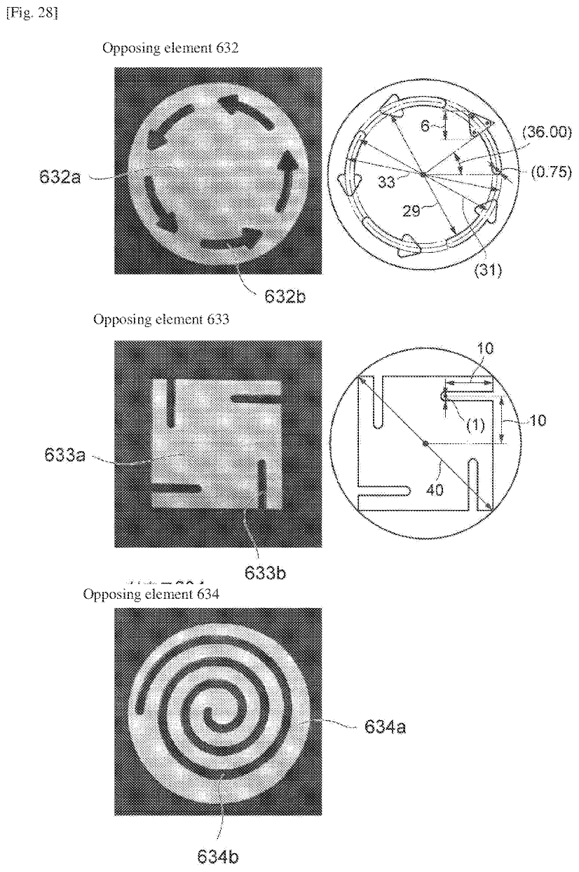

FIGS. 11 through 28 illustrate examples of the shape of the opposing elements applied in modification example 5. Also, FIGS. 11 through 22 show the measurement results of the rotational speed of an opposing element with respect to the vibration amplitude of vibration device 10 when the opposing element shown in FIGS. 11 through 22 is applied to rotating apparatus 1, which was described with reference to FIGS. 1 through 3. Regarding the reference numerals shown in the drawings described below, the reference numerals with “a” added to the reference numerals of the opposing element are the reference numerals of the parallel region, and the reference numerals with “b” added are the reference numerals of the three-dimensional shape. For example, parallel region 601a and three-dimensional shape 601b are formed on the opposing surface of opposing element 601.

Although there are no particular limitations for the realization of the opposing element of modification example 5, for the measurements of the opposing element described in the subsequent explanation of modification example 5, the material is aluminum, the diameter of the opposing surface is 40 mm, and thickness is 2.5 mm unless otherwise mentioned. Also, when the opposing surface is provided with a groove, the groove depth is 1.5 mm.

The outer peripheral shape of the opposing surface of opposing element 601, shown in FIG. 11, is circular, similar to the vibrating surface of the vibrator described above. The opposing surface is formed so that its end portion is facing the end portion of the vibrating surface. For example, the outer circumference circle of the opposing surface and the outer circumference circle of the vibrating surface are formed with the same shape and size.

The opposing surface of opposing element 601 has parallel region 601a and a plurality of three-dimensional shapes 601b. Opposing element 601 has holes, three-dimensional shape 601b, formed at the end portion of the opposing surface. The end portion of opposing element 601 is released by forming holes, three-dimensional shape 601b, at the end of the opposing surface. That is three-dimensional shape 601b formed in opposing element 601 forms slits in the opposing surface.

Also, in opposing element 601, three-dimensional shape 601b formed on the opposing surface is formed along a plurality of radial curves from the center portion to the end portion of the opposing surface. The distance from the outer periphery of the radial curve to the center of the curvature circle of the radial curve is not limited; for example, it is 21 mm. For example, the width of three-dimensional shape 601b in the transverse direction is 2 mm. Even for the opposing element described later in modification example 5, the distance from the outer periphery of the radial curve to the center of the curvature circle of the radial curve and the width in the transverse direction of the three-dimensional shape may be the same as the example shown in FIG. 11, except when otherwise explained.

In opposing element 601, the parallel region is formed at the center portion of the opposing surface. The outer periphery of the parallel region is formed to define a concentric circle with the outer circumference circle of the opposing surface. In other words, three-dimensional shape 601b (or the end portion of three-dimensional shape 601b) formed on the opposing surface of opposing element 601 is formed along a concentric circle, which is concentric with the outer circumference circle of the opposing surface. For the example shown in FIG. 11, although it is not limited, the radius of the outer circumference circle of the parallel region is 27 mm.

The outer circumference circle radius of the parallel region formed in the center portion of the opposing surface may be from 60% to 80% of the outer circumference circle radius of the opposing surface. More preferably, the radius of the outer circumference circle of the parallel region may be from 70% to 80% of the radius of the outer circumference circle radius of the opposing surface.

As described above, for opposing element 601, three-dimensional shapes 601b are formed along a plurality of radial curves from the center portion toward the end portion of the opposing surface. As a result, the adjacent three-dimensional shapes 601b are not symmetric with respect to each other in the radial direction of the opposing surface. That is, the plurality of three-dimensional shapes 601b formed on the opposing surface includes a plurality of adjacent three-dimensional shapes 601b that are not symmetrical to each other in the radial direction of the opposing surface.

As in the examples described below, holes may be formed at the center portion of the opposing surface instead of the parallel regions.

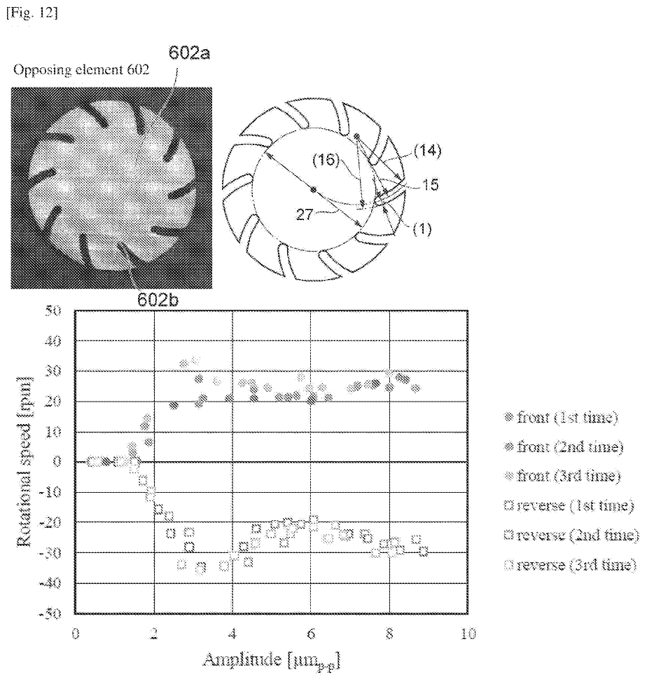

In the graph of the measurement results of the rotational speed of opposing element 601 shown in FIG. 11, the results obtained when the surface of the opposing element shown in the figure is facing the vibrating surface of the vibrator (in other words, facing up) are indicated by “front”, and the results obtained when the rear surface of the surfaces of the opposing element shown in the same figure is facing the vibrating surface of the vibrator are indicated by “reverse”. Also, the measurement of the rotational speed was performed multiple times, and the first, second, and third times are indicated with “1st time”, “2nd time”, and “3rd time”, respectively. This also applies to the graphs shown in FIGS. 12 through 22.

As shown by the graph in FIG. 11, the rotation of opposing element 601 has been confirmed when opposing element 601 is applied to rotating apparatus 1 described with reference to FIGS. 1 through 3.

The opposing surface of opposing element 602 shown in FIG. 12 has parallel region 602a and a plurality of three-dimensional shapes 602b. In opposing element 602, like opposing element 601 shown in FIG. 11, three-dimensional shapes 602b formed on the opposing surface are formed along a plurality of radial curves from the center portion to the end portion of the opposing surface. In opposing element 602, the distance from the outer periphery of the radial curve to the center of the curvature circle of the radial curve is not limited; for example, it is 16 mm. The other configuration of opposing element 602 is similar to opposing element 601.

As shown in the graph of FIG. 12, the rotation of opposing element 602 has been confirmed when opposing element 602 is applied to rotating apparatus 1. As can be ascertained from the graphs in FIG. 11 and FIG. 12, at high vibration amplitudes, a higher rotational speed was observed for opposing element 601 than for opposing element 602.

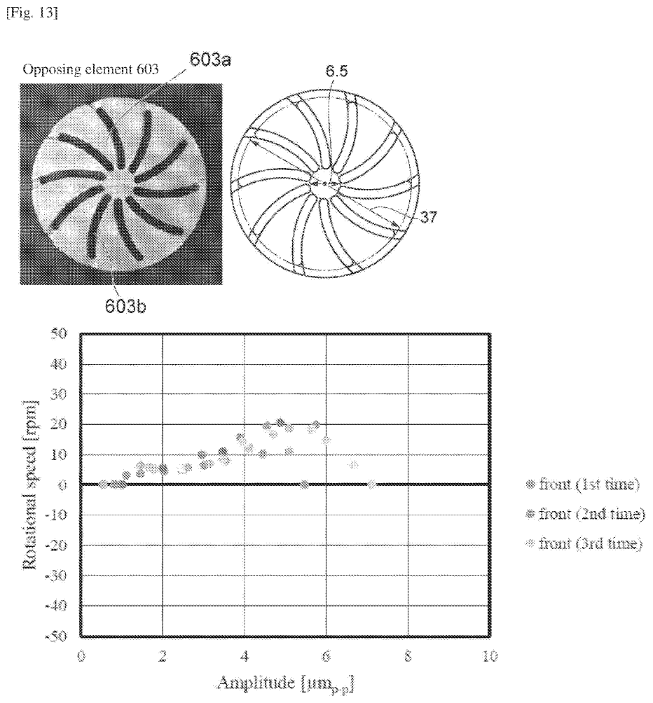

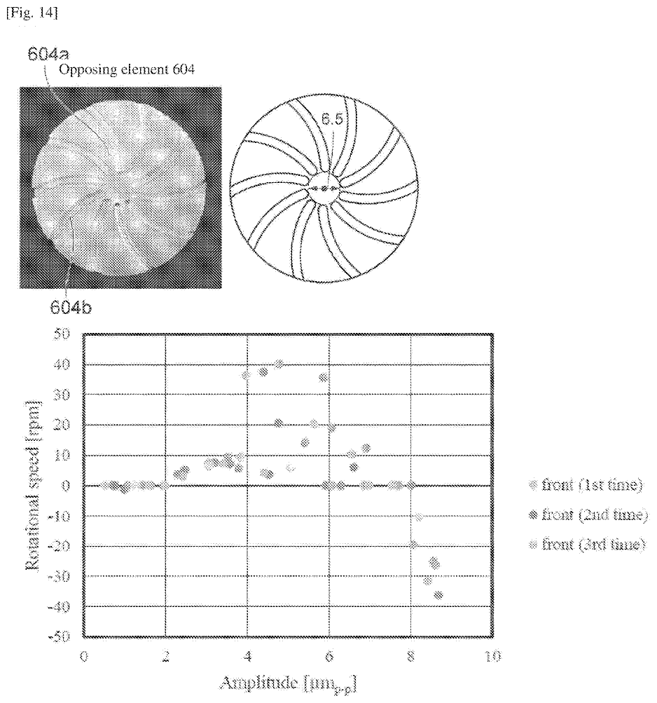

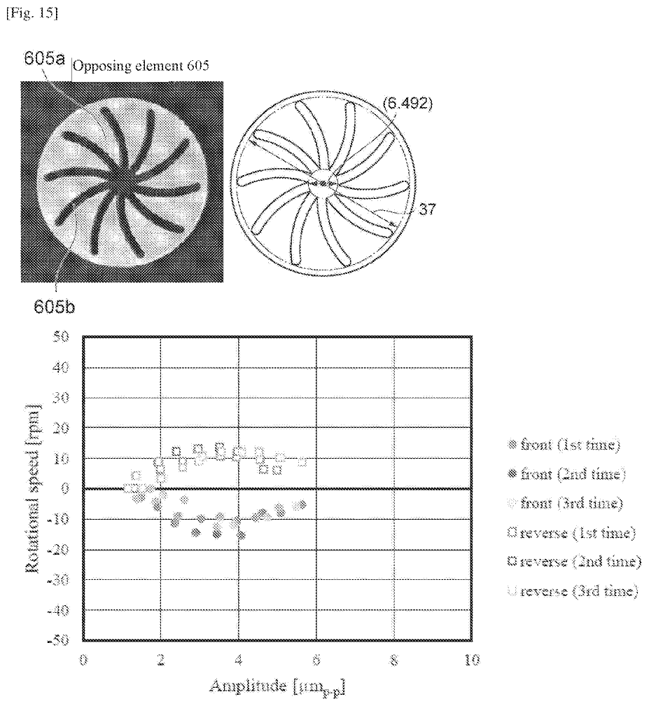

The opposing surface of opposing element 603 shown in FIG. 13 has parallel region 603a and a plurality of three-dimensional shapes 603b. Three-dimensional shape 603b is formed with holes and grooves. Three-dimensional shape 603b is formed by holes along a plurality of radial curves extending from the center portion toward the end portion of the opposing surface, and three-dimensional shape 603b is formed by grooves at the outer peripheral end portion of the opposing surface. As a result, unlike opposing element 601, no slit is formed on the opposing surface of opposing element 603. In parallel region 603a, a circular parallel region is formed at the center portion of the opposing surface. Although the circular diameter is not limited, it is 6.5 mm.

The three-dimensional shape 603b is formed along a plurality of radial curves from the center portion toward the end portion of the opposing surface. The distance (radius of curvature) from the outer periphery of the radial curve to the center of the curvature circle of the radial curve is not limited; for example, it is 20 mm. The radius of curvature may be similar in the opposing element described with reference to FIGS. 14 through 22.

As shown in the graph of FIG. 13, the rotation of opposing element 603 has been confirmed when opposing element 603 is applied to rotating apparatus 1.

For the opposing element shown in FIGS. 14 through 22, the rotation of the opposing element was confirmed when opposing element 603 was applied to rotating apparatus 1.

For opposing element 604 shown in FIG. 14, three-dimensional shape 604b is formed by a groove. Three-dimensional shape 604b is formed along a plurality of radial curves from the center portion toward the end portion of the opposing surface.

For opposing element 605 shown in FIG. 15, three-dimensional shape 605b is formed by holes. Three-dimensional shape 605b is formed along a plurality of radial curves extending from the center portion towards the end portion of the opposing surface; however, the three-dimensional shape 605b is not formed at the outer peripheral end portion of the opposing surface.

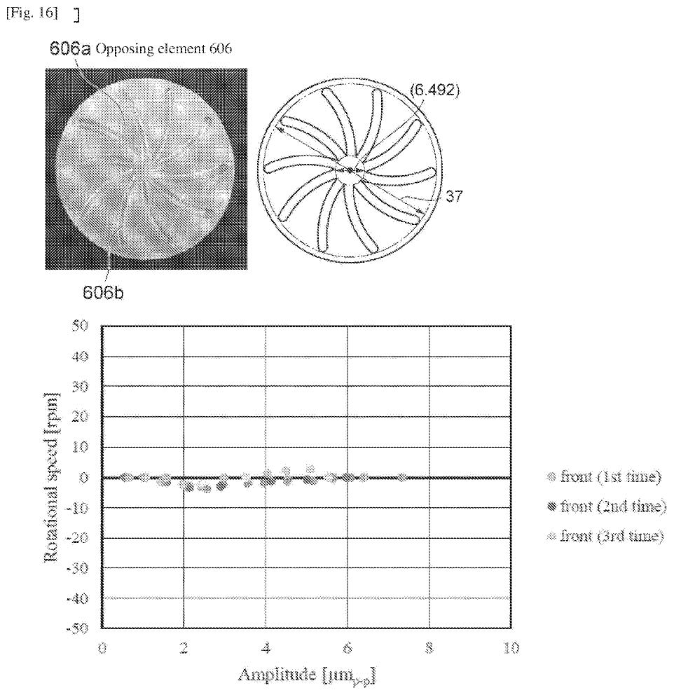

For opposing element 606 shown in FIG. 16, three-dimensional shape 606b is formed by grooves. A three-dimensional shape 606b is formed along a plurality of radial curves extending from the center portion toward the end portion of the opposing surface; however, the three-dimensional shape 606b is not formed at the outer peripheral end portion of the opposing surface.

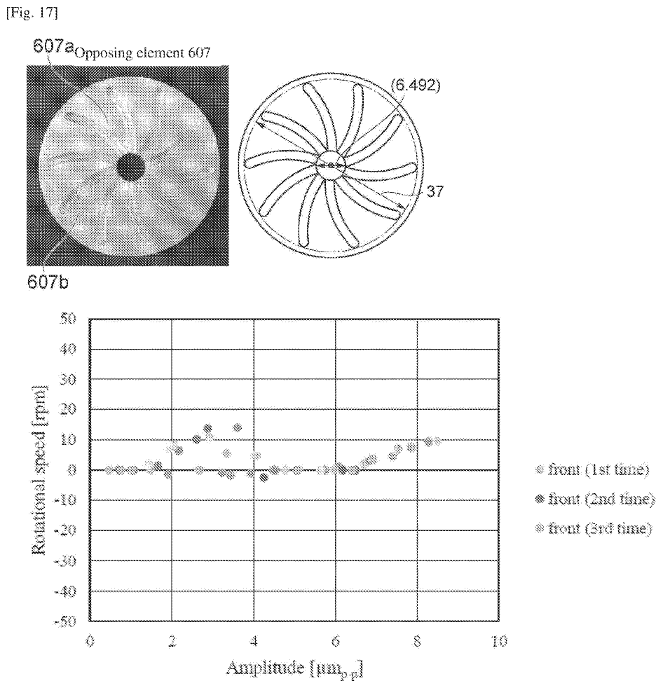

For opposing element 607, shown in FIG. 17, three-dimensional shape 607b is formed by grooves and a hole. Three-dimensional shape 607b is formed by grooves along a plurality of radial curves extending from the center portion toward the end portion of the opposing surface; however, three-dimensional shape 607b is not formed at the outer peripheral end portion of the opposing surface. At the center portion of the opposing surface, three-dimensional shape 607b is formed in a circular shape by a hole.

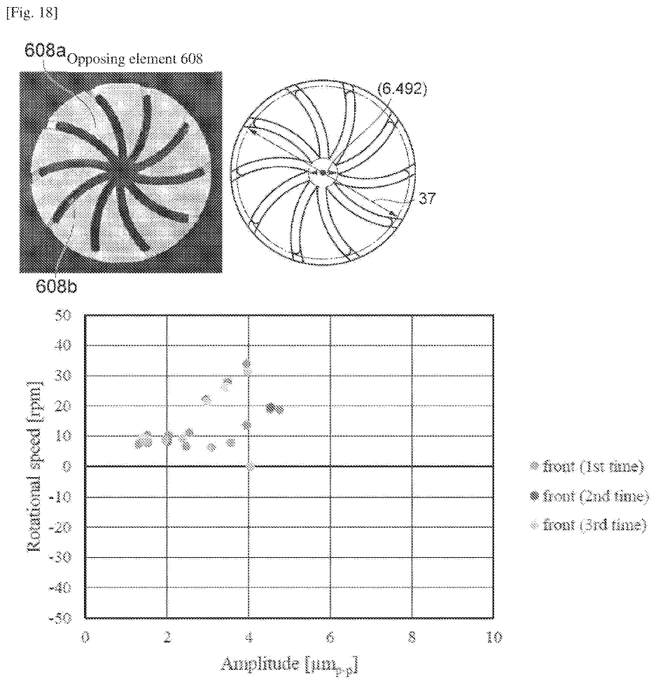

For opposing element 608, shown in FIG. 18, three-dimensional shape 608b is formed with holes and grooves. Three-dimensional shape 608b is formed by holes along a plurality of radial curves extending from the center portion towards the end portion of the opposing surface, and three-dimensional shape 608b is formed by grooves at the outer peripheral end portion of the opposing surface. Unlike opposing element 603, opposing element 608 is not provided with a parallel region at the center portion of the opposing surface.

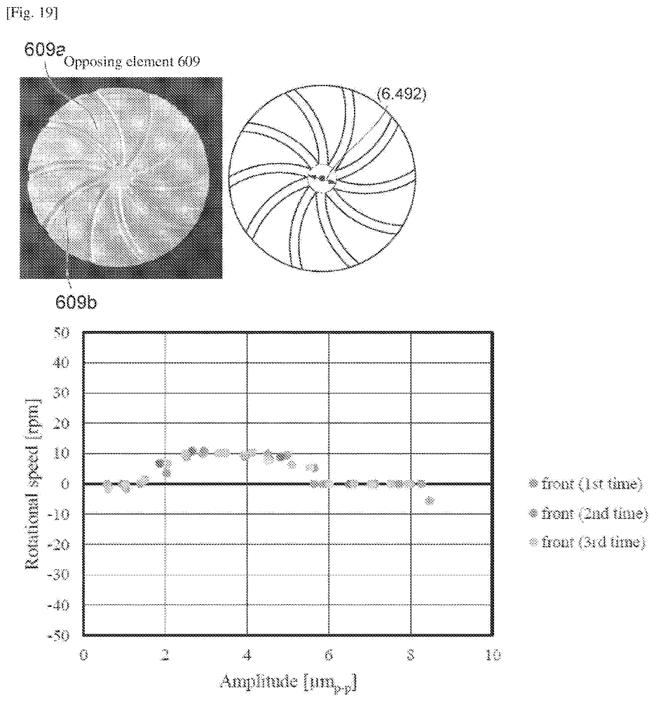

For opposing element 609 shown in FIG. 19, three-dimensional shape 609b is formed with grooves. Three-dimensional shape 609b is formed by grooves along a plurality of radial curves from the center portion toward the end portion of the opposing surface.

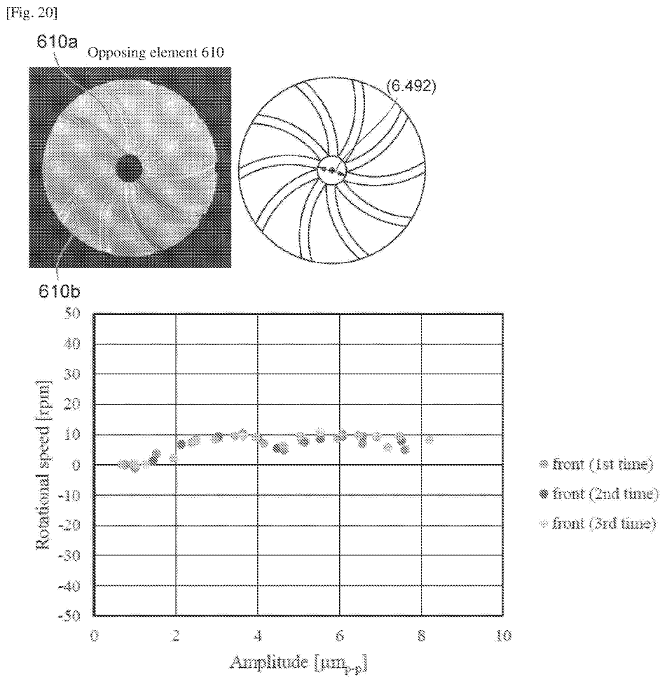

For opposing element 610, shown in FIG. 20, three-dimensional shape 610b is formed with holes and grooves. Three-dimensional shape 610b is formed by grooves along a plurality of radial curves from the center portion toward the end portion of the opposing surface. In addition, at the center portion of the opposing surface, three-dimensional shape 610b is formed in a circular shape by a hole.

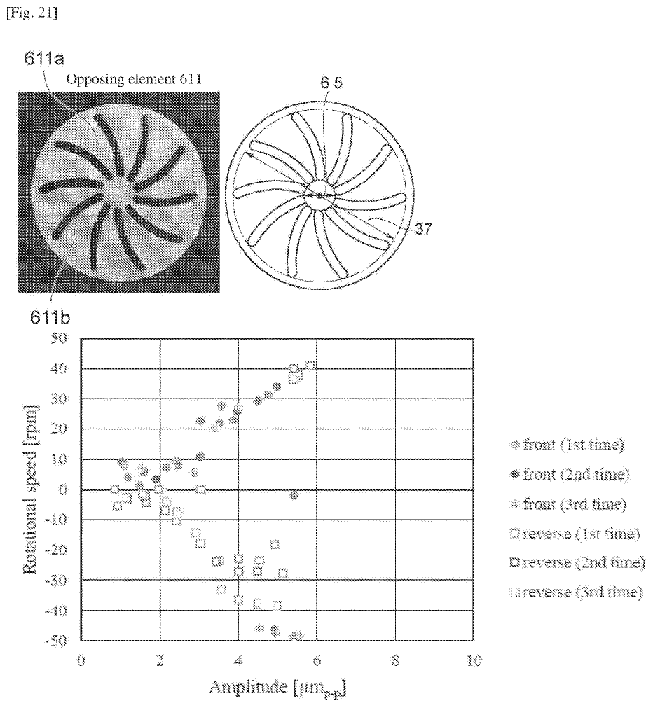

For opposing element 611 shown in FIG. 21, three-dimensional shape 611b is formed by holes. Three-dimensional shape 611b is formed by holes along a plurality of radial curves from the center portion toward the end portion of the opposing surface. Three-dimensional shape 611b is not formed at the outer peripheral end portion of the opposing surface. Also, parallel region is provided in a circular shape at the center of the opposing surface.

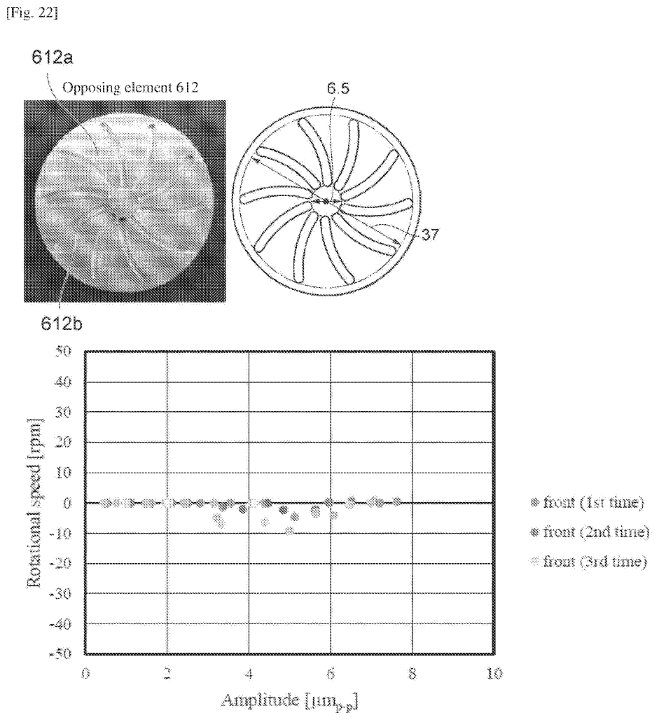

For opposing element 612 shown in FIG. 22, three-dimensional shape 612b is formed by grooves. Three-dimensional shape 612b is formed by grooves along a plurality of radial curves from the center portion toward the end portion of the opposing surface. Three-dimensional shape 612b is not formed at the outer peripheral end portion of the opposing surface. Also, parallel region 612a is provided in a circular shape at the center portion of the opposing surface.

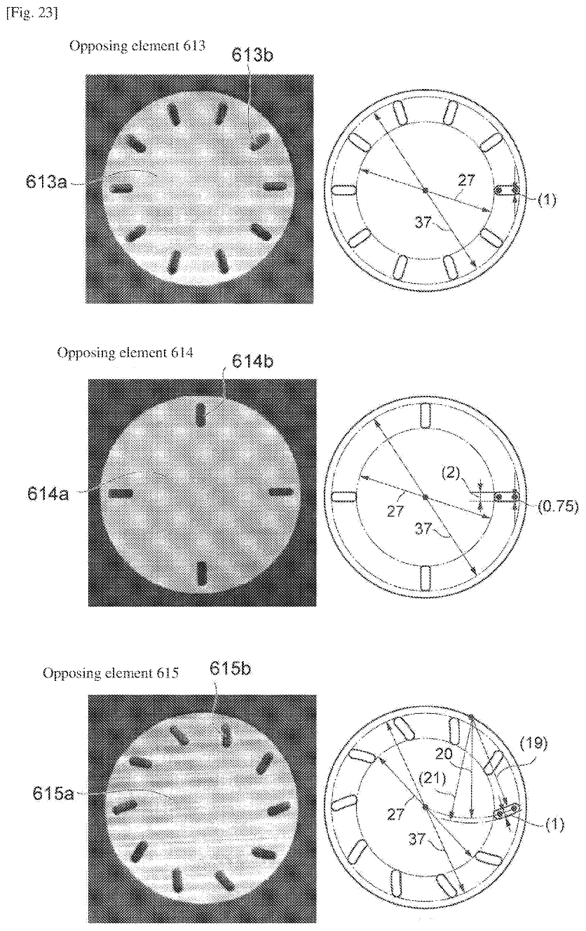

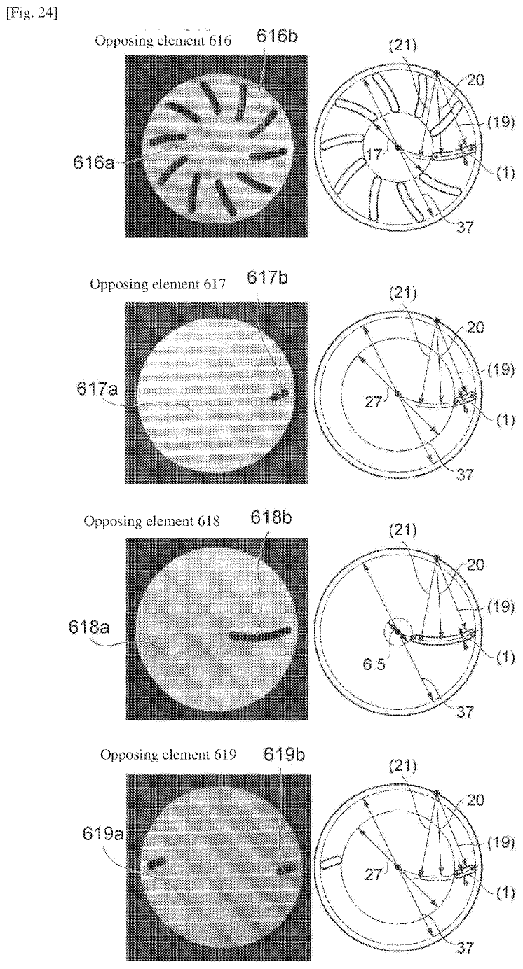

Regarding opposing element 613 to opposing element 634 shown in FIGS. 23 through 28, the measurement results are not shown, but when an opposing element is applied to rotating apparatus 1, it is described with reference to FIGS. 1 through 3, the presence of the rotation of the opposing element was confirmed. Although no clear rotation was observed with opposing element 614, opposing element 617 and opposing element 633, rotation was observed with other opposing elements Also, the rotation of opposing element 618 through opposing element 620 was negligible. For opposing elements with negligible rotation, it is conceivable that more rotation can be achieved by applying a separate initial rotation torque to the opposing element.

The shapes of opposing elements 613 through 634, worth mentioning, are described. Note that in FIGS. 23 through 28, the photograph of the opposing element is shown on the left side and the schematic diagram on the right. The solid black shape in the photograph is a hole, and the other three-dimensional shape is a groove.

For opposing surfaces of opposing element 613 and opposing element 614, adjacent three-dimensional shapes are formed symmetrically with respect to each other in the radial direction of the opposing surface.

The difference between opposing element 615 and opposing element 624 is that the three-dimensional shape 615b of opposing element 615 is formed by a hole, whereas the three-dimensional shape 624b of opposing element 624 is formed by a groove.

The opposing surface of opposing element 626 has parallel region 626a and a plurality of three-dimensional shapes 626b. Three-dimensional shape 626b formed by grooves has a larger area than other opposing elements, such as the opposing element 601 through opposing element 612. The center portion of the opposing surface of opposing element 626 in parallel region 626a is substantially circular. The opposing surface of opposing element 627 is also formed in a wide area with three-dimensional shape 627b in the same manner as the opposing element 626. The opposing surface of opposing element 627 differs from opposing element 626 in that the center portion is a three-dimensional shape formed by a hole.

The opposing surface of opposing element 628 has parallel region 628a and a plurality of three-dimensional shapes 628b. Three-dimensional shape 628b is formed by convex portions.

The opposing surface of opposing element 629 has parallel region 629a and a plurality of three-dimensional shapes 629b. Three-dimensional shape 629b is formed by a plurality of holes. Three-dimensional shape 629b may be formed by a plurality of grooves or a combination of holes and grooves.

Opposing element 631 is also used in the modification example 6 described below. The rotation of opposing element 631 has been confirmed in modification example 5.

The outer peripheral shape of the opposing surface of opposing element 633 is rectangular. The outer peripheral shape of the opposing surface of opposing element 633 differs from the outer peripheral shape of the vibrating surface of the vibrator. Accordingly, the opposing surface of opposing element 633 is not formed so that the end portion faces the end portion of the vibrating surface. As described above, a clear rotation of opposing element 633 could not be confirmed.

The opposing surface of opposing element 634 has parallel region 634a and three-dimensional shape 634b. Three-dimensional shape 634b is formed along a spiral curve from the center portion to the end portion of the opposing surface of opposing element 634. Three-dimensional shape 634b may be an Archimedes spiral shape. In this case, although the width of the three-dimensional shape 634b in the transverse direction is not limited, it may be 5 mm. The three-dimensional shape formed on the opposing surface of opposing element 634 is one. As mentioned above, the rotation of opposing element 634 has been confirmed.

### Modification Example 6

In modification example 5, an example is described in which an opposing element formed with a three-dimensional shape other than the impeller shape is applied to rotating apparatus 1 described with reference to FIGS. 1-3 and rotated (in other words, an example in which an opposing element is rotated in water). In modification example 6, an example of rotating an opposing element formed with a three-dimensional shape other than the impeller shape in the air is described. Modification example 6 is similar to modification example 3, except it uses an opposing element different from the opposing element in modification example 3. In particular, rotating apparatus 1, described with reference to FIG. 9A, is used as the rotating apparatus.

In modification example 6, for example, the opposing element has an opposing surface that faces the vibrating surface of the vibrator, and the opposing surface has a parallel region that is parallel to the vibrating surface of the vibrator and a plurality of three-dimensional shapes formed to extend towards the end portion of the opposing surface. That is, the vibrating surface and the opposing surface may each have parallel regions that face each other in parallel. The parallel regions may also be planar. The starting point for the formation of the three-dimensional shape extending towards the end portion of the opposing surface may be inside the opposing surface, in particular, at the center portion of the opposing surface.

That is, the three-dimensional shape may be formed on the inner side of the opposing surface or from the center portion of the inner side of the opposing surface toward the end portion of the opposing surface. The parallel region refers to the area where a lifting force (namely, the repulsive force between the opposing surface and the vibrating surface) of the opposing element is generated due to the squeeze film effect described above when in air, between the parallel region and the vibrating surface of the vibrator. The three-dimensional shape is an area considered to generate a rotational force of the opposing element under the action of the fluid.

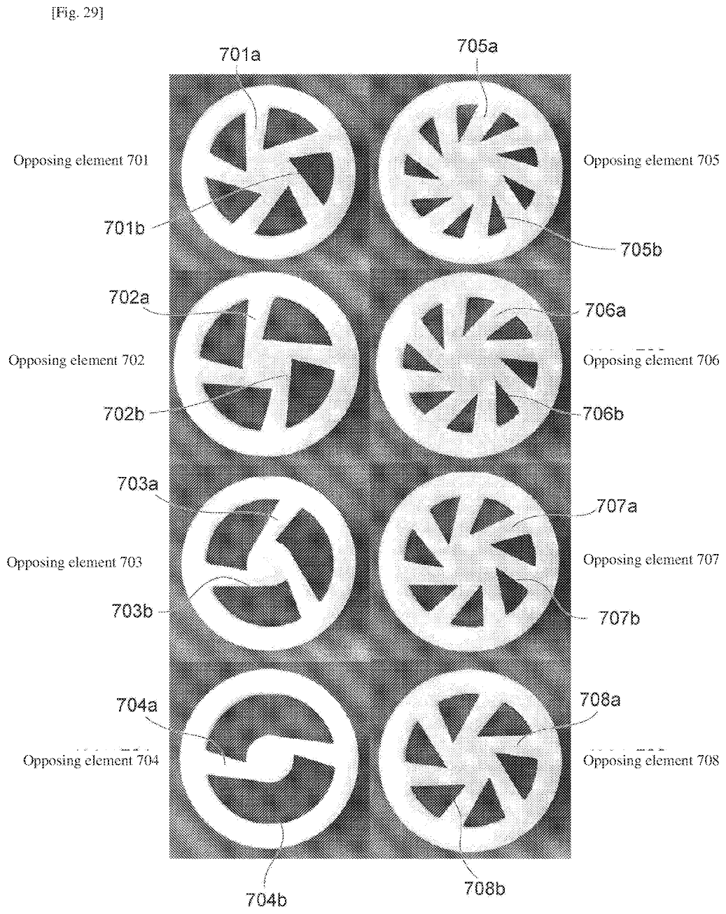

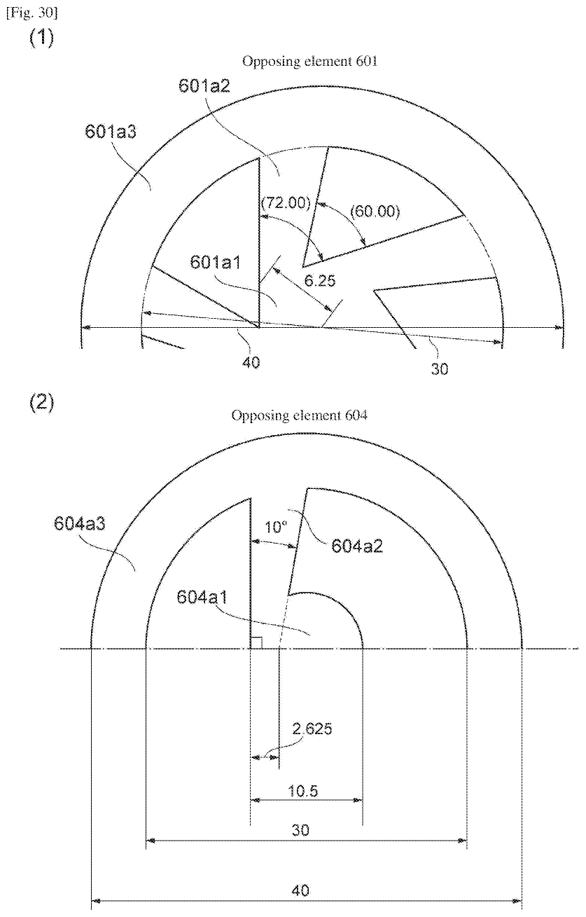

FIG. 29 and FIG. 30 show opposing elements 701 through 708 as examples of the shape of the opposing elements applied in modification example 6. Although the manufacturing method of opposing elements in modification example 6 is not limited, opposing elements shown in FIG. 29 and FIG. 30 were manufactured from ABS resin using 3D printers. Regarding the reference numerals shown in the drawings described below, the reference numerals with “a” added to the reference numerals of the opposing element are the reference numerals of the parallel region, and the reference numerals with “b” added are the reference numerals of the three-dimensional shape. For example, parallel region 701a and three-dimensional shape 701b are formed on the opposing surface of opposing element 701.

The opposing surface of opposing element 701 has parallel region 701a and three-dimensional shape 702b. Parallel region 701a comprises center portion 701a1, beam 701a2 and peripheral portion 701a3. Center portion 701a1 is an area at the center portion of the opposing surface. Peripheral portion 701a3 is an area of the peripheral portion on the opposing surface. Beam 701a2 is an area that connects center portion 701a1 and peripheral portion 701a3. Three-dimensional shape 701b is formed by a hole. Opposing elements 702 through 708 have a parallel region and three-dimensional shape. The parallel region has a center portion, beam, and peripheral portion. Opposing elements 701 through 708 each have a different number of beams, and the number of beams is from 2 to 9.

The two sides of the beam connecting the center portion of the opposing surface and the peripheral portion may or may not be parallel to each other. For example, if the sides are not parallel, the angle formed by the intersection in the longitudinal direction of the 2 side surfaces of beam 704a2 of opposing element 704 is 10°. Also, the diameter of center portion 704a1 of the opposing element 704 is 10.5 mm. The diameter of the outer circumference circle of peripheral portion 704a3 of opposing element 704 is 40 mm, and the inner circumference circle is 30 mm.

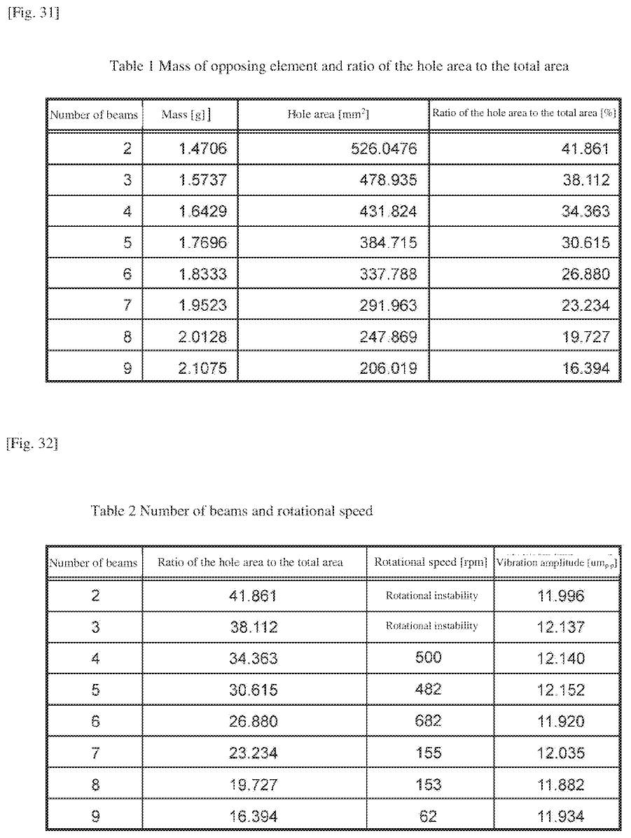

FIG. 31 shows the relationship between the number, mass, hole area, and the ratio of the hole area to the total area of the beam of the opposing element shown in FIG. 29.

FIG. 32 shows the relationship between the number of beams of the opposing element shown in FIG. 29, the ratio of the hole area to the total area, the rotational speed of the opposing element, and the vibration amplitude of the vibrator.

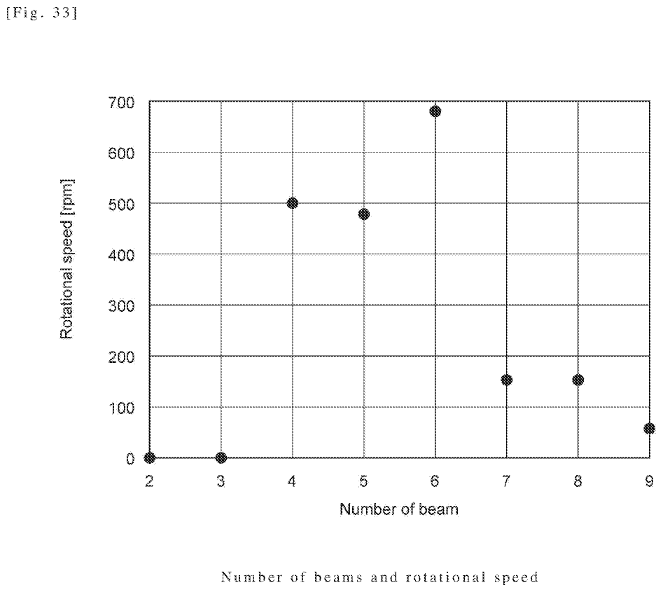

FIG. 33 shows the relationship between the number of beams in the opposing element shown in FIG. 29 and the rotational speed. According to FIGS. 32 and 33, the rotational speed of an opposing element (in other words, opposing element 708) with 6 beams is faster than the other opposing elements.

### Other Modification Examples

A motor with rotating apparatus 1 in the above embodiment and modification examples may be configured. In this case, the motor may be driven by rotating the opposing element.

A pump with rotating apparatus 1 in the above embodiment and modification examples may be configured to drive the pump by rotating the opposing element. In this case, rotating apparatus 1 may provide the function of the pump by sucking the fluid from the through-hole provided in the vibration device of rotating apparatus 1 and sending it out of the vibration device.

Opposing element 20 of rotating apparatus 1 in the above embodiment is configured to rotate about the vibration direction of vibration device 10; however, as a modification example, opposing element 20 may be fixed so as not to rotate. For example, as a modification example of rotating apparatus 1 having vibration device 10 (vibrator) and opposing element 20 shown in FIG. 1, opposing element 20 may have an opposing surface facing the vibrating surface, and the vibrating surface and the opposing surface may be fixed so that they face each other at a distance. The fixing here may mean that opposing element 20 is immobile and does not rotate at a predetermined position. Opposing element 20 may be fixed, for example, via a support member or by being integrally formed with the fixed member. Opposing element 20 may be fixed so that the position of the center portion of the vibrating surface and the position of the center portion of the surface portion of opposing element 20 come close to each other. The fixing of opposing element 20 does not limit the distance between the vibrating surface and the opposing surface; it may be set to 10-500 microns.

The vibrating surface and the opposing surface may have the same shape (for example, circular). Similar to the example shown in FIG. 1, rotating apparatus 1 in this modification may have a parallel region in which each of the vibrating surfaces and the opposing surfaces are parallel to each other and an impeller region three-dimensionally formed in at least one of the parallel regions. Also, a pump with the rotating apparatus in the modification example may be configured. The pump may be formed, for example, by providing a through-hole in the vibration device, as in the example of FIG. 8A. In the modification example, since the opposing element is fixed, it is possible to suppress a reduction in pressure due to the generation of a pump effect in the space formed between the vibrating surface and the surface portion of opposing element 20 compared to the case where the opposing element rotates.

While an embodiment and modification examples are described, those skilled in the art can make various further variations and modifications based on this embodiment and modification examples, and these variations and modifications are included in this embodiment. The functions or the like included in each means, or the like can be rearranged so as not to be logically contradictory, and a plurality of means, steps, etc., can be combined into one or divided.

### EXPLANATION OF THE REFERENCE NUMERALS

1 Rotating apparatus
10 Vibration device
11 Vibrator
12 Horn
20, 211, 212, 213 Opposing element
30 Fixture
40 Z-axis stage
50 Water tank
60 Temperature probe
101,102,103,104,105 Vibration device

What is claimed is:

1. A rotating apparatus characterized by being equipped with a vibrator having a vibrating surface perpendicular to the vibration direction and
an opposing element having an opposing surface facing the vibrating surface and rotating with the vibration direction of the vibrator as the axis;
Wherein the vibrating surface and the opposing surface each have a parallel region that face each other in parallel and an impeller region that is three-dimensionally formed in at least one of the parallel regions.

2. A rotating apparatus, as claimed in claim 1, wherein the opposing element has a convex portion formed on the opposing surface along the end portion of the opposing surface.

3. A rotating apparatus, as claimed in claim 2, wherein a space is formed by the vibrating surface and the opposing surface.

4. A rotating apparatus, as claimed in claim 1, wherein the vibrating surface and the opposing surface are each circular, and an end portion of the vibrating surface faces an end portion of the opposing surface.

5. A rotating apparatus, as claimed in claim 1, wherein the opposing surface has through-hole No. 1 formed toward the back surface of the opposing element.

6. A rotating apparatus, as claimed in claim 5, wherein the through-hole No. 1 is formed in the center of the opposing surface.

7. A rotating apparatus, as claimed in claim 1, wherein the vibration of the vibrator is a single vibration.

8. A rotating apparatus, as claimed in claim 1, wherein the vibrating surface is provided with through-hole No. 2 formed toward the outside of the vibrator via the inside of the vibrator.

9. A motor with a rotating apparatus, as claimed in claim 1.

10. A pump with a rotating apparatus, as claimed in claim 1.

11. A rotating apparatus characterized by being equipped with vibrator No. 1 having vibration surface No. 1 perpendicular to the vibration direction, and
Vibrator No. 2 has vibration surface No. 2 perpendicular to the vibration direction, and
An opposing element having opposing surface No. 1 facing vibrating surface No. 1 and opposing surface No. 2 facing vibrating surface No. 2, and rotating about the vibration direction of vibrator No. 1 and vibrator No. 2 as the axis;
Vibrating surface No. 1 and opposing surface No. 1 each have parallel region No. 1 that face each other in parallel and impeller region No. 1 that is three-dimensionally formed in at least one of parallel region No. 1 and impeller region No. 1, and
Vibrating surface No. 2 and opposing surface No. 2 each have parallel region No. 2 that face each other in parallel, and impeller region No. 2, which is three-dimensionally formed in at least one of parallel region No. 2 and impeller region No. 2.

12. A rotating apparatus, as claimed in claim 11, which does not have a member to support the opposing element.

13. A motor with a rotating apparatus, as claimed in claim 11.

14. A pump with a rotating apparatus, as claimed in claim 11.

15. A rotating apparatus characterized by being equipped with a vibrator having a vibrating surface perpendicular to the vibration direction, and
an opposing element having an opposing surface facing the vibrating surface and rotating with the vibration direction of the vibrator as the axis;
Wherein the vibrating surface and the opposing surface have parallel regions that face each other in parallel, and
The opposing surface has one or a plurality of three-dimensional shapes formed to extend toward the end portion of the opposing surface.

16. A rotating apparatus, as claimed in claim 15, wherein the three-dimensional shape is formed with one or a plurality of grooves or holes.

17. A rotating apparatus, as claimed in claim 15, wherein the plurality of three-dimensional shapes comprises a plurality of adjacent three-dimensional shapes that are not symmetrical to each other with respect to the radial direction of the opposing surface.

18. A rotating apparatus, as claimed in claim 15, wherein 4 or more three-dimensional shapes are formed on the opposing surface.

19. A rotating apparatus, as claimed in claim 15, wherein a hole is formed at the center portion of the opposing surface.

20. A rotating apparatus, as claimed in claim 15, wherein a parallel region is formed at the center portion of the opposing surface.

21. A rotating apparatus, as claimed in claim 20, wherein the radius of the outer circumference circle of the parallel region formed at the center portion of the opposing surface is between 60% and 80% of the radius of the outer circumference circle of the opposing surface.

22. A rotating apparatus, as claimed in claim 20, wherein the three-dimensional shape is formed as a slit in the opposing surface.

23. A rotating apparatus, as claimed in claim 15, wherein the outer peripheral shape of the vibrating surface and the opposing surface are each circular, and the end portion of the vibrating surface faces the end portion of the opposing surface.

24. A rotating apparatus, as claimed in claim 15, wherein the three-dimensional shape is formed along a plurality of radial curves from the center portion to the end portion of the opposing surface.

25. A rotating apparatus, as claimed in claim 15, wherein the three-dimensional shape is formed along a plurality of spiral curves from the center portion to the end portion of the opposing surface.

26. A rotating apparatus, as claimed in claim 15, wherein the three-dimensional shape is formed along a concentric circle that is concentric with the outer circumference circle of the opposing surface of the opposing element.

27. A motor with a rotating apparatus, as claimed in claim 15.

28. A pump with a rotating apparatus, as claimed in claim 15.

29. A rotating apparatus characterized by being equipped with a vibrator having a vibrating surface perpendicular to the vibration direction, and
An opposing element having an opposing surface facing the vibrating surface;
The opposing element is fixed so that the vibrating surface and the opposing surface are spaced apart and facing each other,
The vibrating surface and the opposing surface parallel region that face each other in parallel, and an impeller region, which is three-dimensionally formed in at least one of the parallel regions.
